(19) United States
(12) Patent Application Publication
(10) Pub. No.: US 2018/0336132 A1
(43) Pub. Date: Nov. 22, 2018

(54) INFORMATION PROCESSING DEVICE, PROCESSOR, AND TRANSMISSION INFORMATION STORAGE METHOD

(71) Applicant: FUJITSU LIMITED, Kawasaki-shi (JP)

(72) Inventors: Makoto SUGA, Edogawa (JP); Koji HOSOE, Yamato (JP); Masatoshi Aihara, Hiratsuka (JP)

(73) Assignee: FUJITSU LIMITED, Kawasaki-shi (JP)

(21) Appl. No.: 15/983,237

(22) Filed: May 18, 2018

(30) Foreign Application Priority Data
May 22, 2017 (JP) 2017-101008

(51) Int. Cl. G06F 12/0811; G06F 12/10

(52) U.S. Cl. CPC G06F 12/0811; G06F 12/10

(57) ABSTRACT

An apparatus includes a memory; and a processor that includes a memory-controller that controls transmission-and-reception of information to and from the memory, wherein the memory-controller comprises a buffer that includes storage-regions, a control-circuit that stores, in one of the storage-regions, information that operates the memory among pieces of information transmitted to the memory, a counter that counts a number of pieces of second information transmitted to the memory, the second information being information transmitted to the memory since the information is transmitted to the memory until the next information is transmitted to the memory and indicating no-transmission of the information, a second buffer that includes a second storage-regions respectively corresponding to the storage-regions, and a second control-circuit that stores a count value of the counter in one of the second storage-regions in association with the information stored in the storage region.

### CROSS-REFERENCE TO RELATED APPLICATION

This application is based upon and claims the benefit of priority of the prior Japanese Patent Application No. 2017-101008, filed on May 22, 2017, the entire contents of which are incorporated herein by reference.

### FIELD

The embodiments discussed herein are related to an information processing device, a processor, and a transmission information storage method.

### BACKGROUND

In a signal terminal device which transmits and receives a signal, in a case where a message to be transmitted to an opposite station is stored in a transmission buffer, the message is obtained from the transmission buffer and transmitted to the opposite station, and the transmitted message is accumulated in a retransmission buffer. The message is continued to be stored the retransmission buffer until a complete signal indicating that the message is normally received from the opposite station is received. In this type of the signal terminal device, in a case where an error occurs in data link with the opposite station, by executing a message for obtaining process to the transmission buffer, the number of discarded messages is kept being minimum (for example, see Japanese Laid-open Patent Publication No. 62-213452).

An image communication device which transmits and receives an image is provided with a common storage unit for storing a transmission history, a reception history, and the like of communication by a plurality of protocols, a transmission process, a reception process, so that it is possible to synthetically perform a retransmission process (for example, see Japanese Laid-open Patent Publication No. 2002-232588). In addition, in a case where a specific error occurs, a processing device which performs a process, such as exposure, on a substrate on which a pattern of a device is formed obtains history information before the error occurs from history information for indicating an operation history and stores the history information. Accordingly, a burden for specifying a cause of the error is reduced (for example, see Japanese Laid-open Patent Publication No. 2005-72259).

For example, in a memory controller which controls access of a memory, in some cases, an invalid packet for indicating no-transmission of an operation packet is transmitted to the memory since the operation packet for causing the memory to be operated is transmitted to the memory until the next operation packet is transmitted to the memory. In a case where the memory controller includes a retransmission buffer which stores the transmitted operation packet so as to retransmit the operation packet transmitted to the memory, the retransmission buffer stores information included in the operation packet and does not store information included in the invalid packet.

For example, by providing a buffer storing the operation packet and the invalid packet to the memory controller, it is possible to trace the packet transmitted to the memory by using information stored in the buffer. Accordingly, it is possible to reproduce an error occurred on a transmission path or the like between the memory controller and the memory. However, as the number of packets storable in the buffer increases, circuit scale of the memory controller increases.

### SUMMARY

According to an aspect of the embodiments, an information processing device includes: a memory; and a processor configured to include a memory controller that controls transmission and reception of information to and from the memory, wherein the memory controller comprises a first buffer that includes a plurality of first storage regions, a first control circuit that stores, in one of the plurality of first storage regions, first information that operates the memory among pieces of information transmitted to the memory, a counter that counts a number of pieces of second information transmitted to the memory, the second information being information transmitted to the memory since the first information is transmitted to the memory until the next first information is transmitted to the memory and indicating no-transmission of the first information, a second buffer that includes a plurality of second storage regions respectively corresponding to the plurality of first storage regions, and a second control circuit that stores a count value of the counter in one of the plurality of second storage regions in association with the first information stored in the first storage region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an embodiment of an information processing device, a processor, and a transmission information storage method;

FIG. 2 is a diagram illustrating an example of an operation of a memory controller illustrated in FIG. 1;

FIG. 3 is a diagram illustrating an example of an operation flow of the memory controller illustrated in FIG. 1;

FIG. 4 is a diagram illustrating another embodiment of the information processing device, the processor, and the transmission information storage method;

FIG. 5 is a diagram illustrating an example of a transmission information recording circuit illustrated in FIG. 4;

FIG. 6 is a diagram illustrating an example of a relationship between an entry of a retry buffer illustrated in FIG. 4 and an entry of a counter buffer illustrated in FIG. 5;

FIG. 7 is a diagram illustrating an example of an operation of the memory controller illustrated in FIG. 4;

FIG. 8 is a diagram illustrating an example of a state of an interrupt processing circuit in a case where an interrupt signal occurs in the information processing device illustrated in FIG. 4;

FIG. 9 is a diagram illustrating an example of an operation of tracing a packet transmitted to a memory by a debugger in the information processing device illustrated in FIG. 4;

FIG. 10 is a diagram illustrating an example of a state of the interrupt processing circuit after the interrupt signal occurs in the information processing device illustrated in FIG. 4;

FIG. 11 is a diagram illustrating an example of an operation flow of the transmission information recording circuit illustrated in FIG. 5;

FIG. 12 is a diagram illustrating still another embodiment of the information processing device, the processor, and the transmission information storage method;

FIG. 13 is a diagram illustrating an example of the transmission information recording circuit illustrated in FIG. 12;

FIG. 14 is a diagram illustrating an example of an operation of the memory controller illustrated in FIG. 12;

FIG. 15 is a diagram illustrating another example of an operation of the memory controller illustrated in FIG. 12; and

FIG. 16 is a diagram illustrating an example of an operation flow of the transmission information recording circuit illustrated in FIG. 13.

### DESCRIPTION OF EMBODIMENTS

Hereinafter, embodiments will be described with reference to drawings.

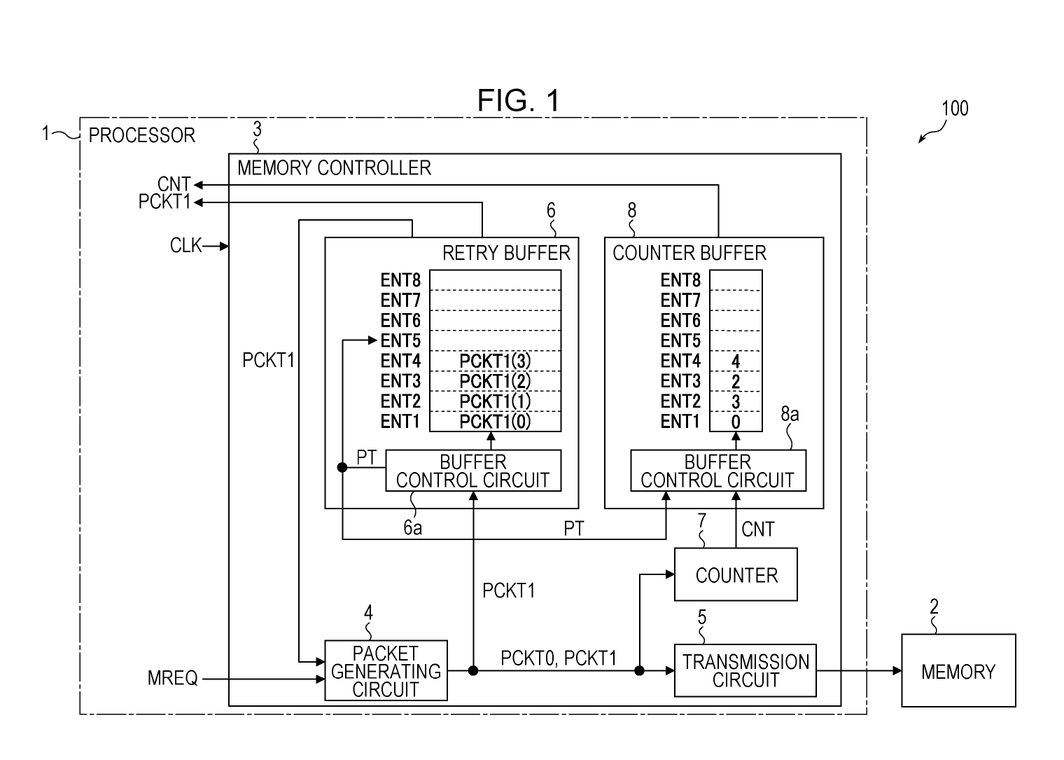

FIG. 1 illustrates one embodiment of an information processing device, a processor, and a transmission information storage method. An information processing device 100 illustrated in FIG. 1 includes a processor 1 which executes an operating process and a memory 2 such as a main memory unit which stores information. For example, the processor 1 includes a memory controller 3 which controls transmission and reception of information to and from the memory 2. Further, the processor 1 includes a processor core, a cache memory, and the like.

The memory controller 3 includes a packet generation circuit 4, a transmission circuit 5, a retry buffer 6, a counter 7, and a counter buffer 8. In FIG. 1, description of a circuit of a reception system for processing information received from the memory 2 and a signal path connected to the circuit of the reception system will be omitted.

For example, the packet generation circuit 4 generates a packet PCKT1 for operating the memory 2, based on a memory access request MREQ output by the cache memory when cache miss occurs. The packet generation circuit 4 can generate the packet PCKT1 again based on information included in the packet PCKT1 stored in the retry buffer 6. Further, the packet generation circuit 4 generates a packet PCKT0 indicating no-transmission of the packet PCKT1 since the packet PCKT1 is transmitted until the next packet PCKT1 is transmitted. For example, all of bits of information included in the packet PCKT0 are set to “zero”. The packet generation circuit 4 may output information of a plurality of bits included in each of the generated packets PCKT1 and PCKT0 in parallel. The packet PCKT1 is output to the transmission circuit 5 and the retry buffer 6. The packet PCKT0 is output to the transmission circuit 5. The packet PCKT1 is one example of first information and the packet PCKT0 is one example of second information. Hereinafter, the packet PCKT1 and the packet PCKT0 are also referred to as “packet PCKT”. The packet generation circuit 4 is one example of an information generation circuit.

The transmission circuit 5 transmits the packet PCKT received from the packet generation circuit 4 to the memory 2 in order. For example, the transmission circuit 5 receives information of a plurality of bits included in the packet PCKT in parallel, converts the received information of the plurality of the bits in series, and transmits the information of the plurality of the bits to the memory 2. For this reason, the transmission circuit 5 receives the packet PCKT in synchronization with a clock CLK which operates the packet generation circuit 4 and transmits the packet PCKT in synchronization with a clock with a frequency higher than the clock CLK to the memory 2. For example, the frequency higher than the clock CLK is generated by multiplying a frequency of the clock CLK.

The retry buffer 6, the counter 7, and the counter buffer 8 are operated in synchronization with the clock CLK. The retry buffer 6 includes a plurality of entries ENT (ENT1 to ENT8) in which the information included in the packet PCKT1 to be transmitted to the memory 2 is stored and a buffer control circuit 6a which controls the entries ENT to store the information included in the packet PCKT1 in one of the entries ENT. The entries ENT1 to ENT8 of the retry buffer 6 are examples of a first storage region and the buffer control circuit 6a is one example of a first control circuit.

Hereinafter, the information included in the packet PCKT1 is also referred to as “packet PCKT1”. The buffer control circuit 6a updates a value of a pointer PT indicating the entry ENT which stores the packet PCKT1 from “1” to “8” in order whenever the packet PCKT1 is stored in the entry ENT. The buffer control circuit 6a may cyclically update the value of the pointer PT so that the retry buffer 6 functions as a ring buffer. Further, the buffer control circuit 6a may control an operation of the retry buffer 6 by using a write pointer indicating the entry ENT for writing the packet PCKT1 and a read pointer indicating the entry ENT for reading the packet PCKT1. Hereinafter, the value of the pointer PT is also referred to as “pointer value PT”.

As illustrated in FIG. 1, the buffer control circuit 6a respectively stores the packets PCKT1(0), PCKT1(1), PCKT1(2), and PCKT1(3) transmitted to the memory 2 in order in the entries ENT1, ENT2, ENT3, and ENT4 of the retry buffer 6. The buffer control circuit 6a updates a value indicating the entry ENT5 storing the next packet PCKT1 to be transmitted to the memory 2 into the pointer value PT. The information included in the packet PCKT1 stored in each of the entries ENT of the retry buffer 6 can be read by an outside of the memory controller 3.

In a case where the memory controller 3 receives an error response, indicating that the packet PCKT1 is not normally received, from the memory 2, the packet generation circuit 4 reads information included in the packet PCKT1 corresponding to the error response from the retry buffer 6. The packet generation circuit 4 generates the packet PCKT1 again, based on the read information and outputs the generated packet PCKT1 to the transmission circuit 5 again.

The counter 7 counts the number of the packets PCKT0 transmitted to the memory 2 since the packet PCKT1 is transmitted until the next packet PCKT1 is transmitted. At this time, the counter 7 may count the number of the clocks CLK generated since the packet PCKT1 is transmitted until the next packet PCKT1 is transmitted as the number of the packets PCKT0. The counter 7 outputs the count value CNT obtained by counting the number of the packets PCKT0 to the counter buffer 8. The count value counted by the counter 7 stops at a maximum value without wrap around after reaching the maximum value.

The counter buffer 8 includes a plurality of entries ENT (ENT1 to ENT8) in which the count value CNT is stored and a buffer control circuit 8a which controls the entries ENT to store the count value CNT in one of the entries ENT. The entries ENT1 to ENT8 of the counter buffer 8 are examples of a second storage region and the buffer control circuit 8a is one example of a second control circuit. Each of the entries ENT of the counter buffer 8 is provided to be corresponded to each of the entries ENT of the retry buffer 6. The number of the entries ENT of the retry buffer 6 and the counter buffer 8 is not limited to eight.

Whenever the packet PCKT1 is generated, the buffer control circuit 8a stores the count value CNT counted by the counter 7 in the entry ENT corresponding to the entry ENT of the retry buffer 6 in which the generated packet PCKT1 is stored. The count value CNT stored in each of the entries ENT of the counter buffer 8 can be read by an outside of the memory controller 3.

As illustrated in FIG. 1, the buffer control circuit 8a respectively stores the count values CNT of “0”, “3”, “2”, and “4” in the entries ENT1 to ENT4 of the counter buffer 8. The count value CNT of (“0”) stored in the entry ENT1 indicates an initial value and does not have a special meaning in FIG. 1. The count value CNT of (“3”) stored in the entry ENT2 indicates that the three packets PCKT0 are transmitted to the memory 2 since the packet PCKT1(0) is transmitted until the packet PCKT1(1) is transmitted. The count value CNT of (“2”) stored in the entry ENT3 indicates that the two packets PCKT0 are transmitted to the memory 2 since the packet PCKT1(1) is transmitted until the packet PCKT1(2) is transmitted. The count value CNT of (“4”) stored in the entry ENT4 indicates that the four packets PCKT0 are transmitted to the memory 2 since the packet PCKT1(2) is transmitted until the packet PCKT1(3) is transmitted.

The count value CNT stored in the entry ENT1 of the counter buffer 8 has a meaning in a case where the retry buffer 6 functions as a ring buffer. That is, the count value CNT stored in the entry ENT1 of the counter buffer 8 indicates the number of the packets PCKT0 transmitted to the memory 2 since the packet PCKT1 stored in the entry ENT8 of the retry buffer 6 is transmitted until the packet PCKT1 stored in the entry ENT1 of the retry buffer 6 is transmitted in order.

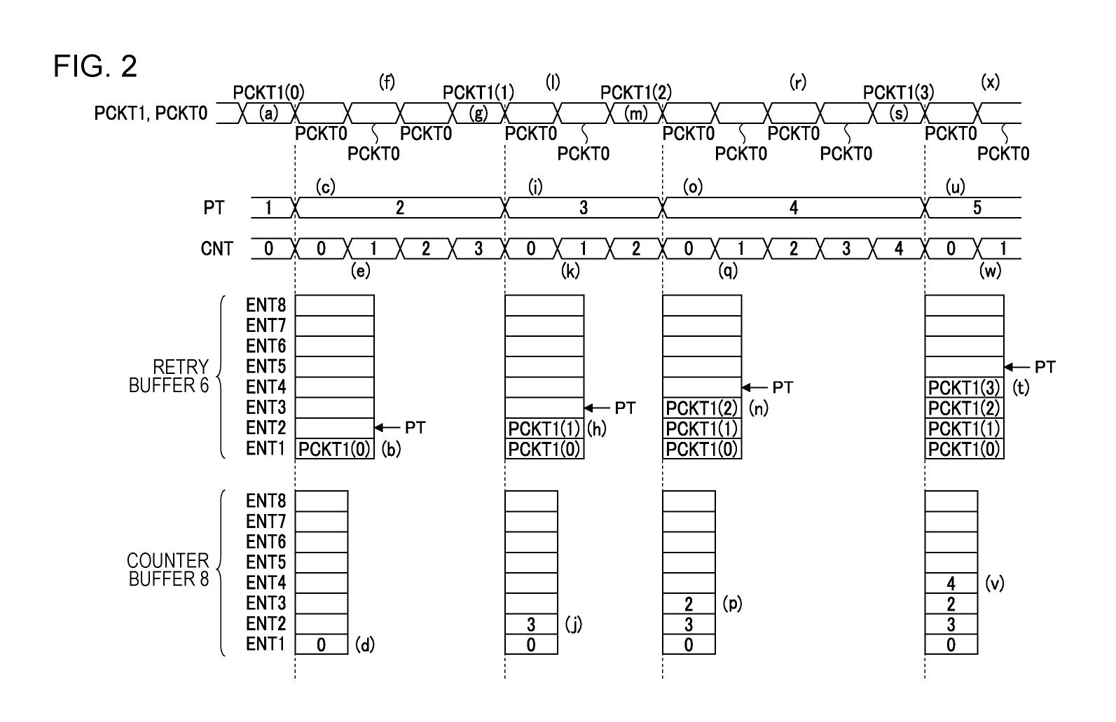

FIG. 2 illustrates an example of the memory controller 3 illustrated in FIG. 1. That is, FIG. 2 illustrates an example of the transmission information storage method and an example of a control method of the memory controller 3. FIG. 2 illustrates an operation of the memory controller 3 from an initial state to the state illustrated in FIG. 1 of the entries ENT of the retry buffer 6 and the entries ENT of the counter buffer 8.

In the initial state, the pointer value PT is “1” and the count value CNT is “0”. First, the packet generation circuit 4 generates the packet PCKT1(0) and transmits the generated packet PCKT1(0) to the memory 2 via the transmission circuit 5 ((a) in FIG. 2). The buffer control circuit 6a stores the packet PCKT1(0) in the entry ENT1 indicated by the pointer value PT of (“1”) based on the packet PCKT1(0) output from the packet generation circuit 4 and updates the pointer value PT into “2” ((b) and (c) in FIG. 2). The buffer control circuit 8a stores the count value CNT of (“0”) in the entry ENT1 indicated by the pointer value PT of (“1”) before the retry buffer 6 updates the pointer value PT based on the packet PCKT1(0) output from the packet generation circuit 4 ((d) in FIG. 2). The buffer control circuit 8a may store the count value CNT of (“0”) in the entry ENT1 indicated by the pointer value PT of (“1”) before updating based on the updating of the pointer value PT.

The counter 7 resets the count value CNT to “0” based on transmission of the packet PCKT1(0) to the memory 2 and continues the counting operation ((e) in FIG. 2). The counter 7 may reset the count value CNT to “0” based on updating of the pointer value PT and may continue the counting operation. The packet generation circuit 4 generates the packet PCKT1(0), then generates the three packets PCKT0 in order and transmits the generated three packets PCKT0 to the memory 2 via the transmission circuit 5 ((f) in FIG. 2). The number of the packets PCKT0 generated by the packet generation circuit 4 decreases as a frequency of the memory access request MREQ increases and increases as the frequency of the memory access request MREQ decreases.

Next, the packet generation circuit 4 generates the packet PCKT1(1) and transmits the generated packet PCKT1(1) to the memory 2 via the transmission circuit 5 ((g) in FIG. 2). The buffer control circuit 6a stores the packet PCKT1(1) in the entry ENT2 indicated by the pointer value PT of (“2”) and updates the pointer value PT into “3” ((h) and (i) in FIG. 2). The buffer control circuit 8a stores the count value CNT of (“3”) in the entry ENT2 indicated by the pointer value PT of (“2”) before the retry buffer 6 updates the pointer value PT ((j) in FIG. 2).

The count value CNT of (“3”) indicates the number of the packets PCKT0 transmitted to the memory 2 since the packet PCKT1(0) is transmitted until the packet PCKT1(1) is transmitted. The counter 7 resets the count value CNT to “0” based on transmission of the packet PCKT1(1) to the memory 2 and continues the counting operation ((k) in FIG. 2). The packet generation circuit 4 generates the packet PCKT1(1), then generates the two packets PCKT0 in order and transmits the generated two packets PCKT0 to the memory 2 via the transmission circuit 5 ((l) in FIG. 2). Next, the packet generation circuit 4 generates the packet PCKT1(2) and transmits the generated packet PCKT1(2) to the memory 2 via the transmission circuit 5 ((m) in FIG. 2). The buffer control circuit 6a stores the packet PCKT1(2) in the entry ENT3 indicated by the pointer value PT of (“3”) and updates the pointer value PT into “4” ((n) and (o) in FIG. 2).

The buffer control circuit 8a stores the count value CNT of (“2”) in the entry ENT3 indicated by the pointer value PT of (“3”) before the retry buffer 6 updates the pointer value PT ((p) in FIG. 2). The count value CNT of (“2”) indicates the number of the packets PCKT0 transmitted to the memory 2 since the packet PCKT1(1) is transmitted until the packet PCKT1(2) is transmitted. The counter 7 resets the count value CNT to “0” based on transmission of the packet PCKT1(2) to the memory 2 and continues the counting operation ((q) in FIG. 2). The packet generation circuit 4 generates the packet PCKT1(2), then generates the four packets PCKT0 in order and transmits the generated four packets PCKT0 to the memory 2 via the transmission circuit 5 ((r) in FIG. 2).

Next, the packet generation circuit 4 generates the packet PCKT1(3) and transmits the generated packet PCKT1(3) to the memory 2 via the transmission circuit 5 ((s) in FIG. 2). The buffer control circuit 6a stores the packet PCKT1(3) in the entry ENT4 indicated by the pointer value PT of (“4”) and updates the pointer value PT into “5” ((t) and (u) in FIG. 2). The buffer control circuit 8a stores the count value CNT of (“4”) in the entry ENT4 indicated by the pointer value PT of (“4”) before the retry buffer 6 updates the pointer value PT ((v) in FIG. 2). The count value CNT of (“4”) indicates the number of the packets PCKT0 transmitted to the memory 2 since the packet PCKT1(2) is transmitted until the packet PCKT1(3) is transmitted.

The counter 7 resets the count value CNT to “0” based on transmission of the packet PCKT1(3) to the memory 2 and continues the counting operation ((w) in FIG. 2). The packet generation circuit 4 generates the packet PCKT1(3), then generates a plurality of the packets PCKT0 in order and transmits the generated packets PCKT0 to the memory 2 via the transmission circuit 5 ((x) in FIG. 2). Accordingly, the entries ENT of the retry buffer 6 and the entries ENT of the counter buffer 8 are in the state illustrated in FIG. 1. For example, a debugging program executed by the processor 1 reads the information stored in the retry buffer 6 and the counter buffer 8, so that it is possible to trace contents of the packets PCKT1 and PCKT0 transmitted to the memory 2.

In other words, it is possible to trace the contents of the packets PCKT1 and PCKT0 transmitted to the memory 2 based on contents of the packet PCKT1 stored in the retry buffer 6 and the count value CNT stored in the counter buffer 8. Further, the packets PCKT1 and PCKT0 transmitted to the memory 2 is reproduced and retransmitted to the memory 2 based on a result of the trace, so that it is possible to analyze a cause of an error occurring on a transmission path between the processor 1 and the memory 2.

The information stored in the retry buffer 6 and the counter buffer 8 may be read by a debugger included in the information processing device 100. Otherwise, the information stored in the retry buffer 6 and the counter buffer 8 may be read by an outside device such as a debug device connected to the information processing device 100 via a communication interface included in the information processing device 100.

In a case where the memory controller 3 includes the retry buffer 6, by adding the counter 7 and the counter buffer 8 to the memory controller 3, it is possible to trace contents of the packets PCKT1 and PCKT0 transmitted to the memory 2. As a result, it is possible to trace the contents of the packets PCKT1 and PCKT0 transmitted to the memory 2 while minimizing increase in a circuit scale of the memory controller 3.

For example, by setting each of the entries ENT of the counter buffer 8 to 8 bits, the counter buffer 8 can store information indicating transmission of up to the 255 packets PCKT0 in each of the entries ENT.

Accordingly, even in a case where the 255 packets PCKT0 are inserted between the two packets PCKT1, it is possible to trace the packets PCKT1 and PCKT0 transmitted to the memory 2.

Further, by setting each of the entries ENT of the counter buffer 8 to 10 bits, the counter buffer 8 can store information indicating transmission of up to the 1023 packets PCKT0 in each of the entries ENT. On the other hand, it is conceivable that the memory controller 3 stores the information itself included in the packet PCKT0 to be transmitted to the memory 2.

In this case, for example, a buffer in which the packet PCKT0 is stored is provided in the memory controller 3 instead of the counter 7 and the counter buffer 8 illustrated in FIG. 1. Since the packet PCKT0 is a packet indicating no-transmission of the packet PCKT1, as a transmission interval of the two packets PCKT1 is longer, the number of the packets PCKT0 inserted between the packets PCKT1 increases.

For example, it is assumed that the 1000 entries are provided in the buffer in which the packet PCKT0 is stored and the maximum 200 packets PCKT0 are inserted between the two packets PCKT1. In this case, since the maximum 1400 packets PCKT0 are inserted between the eight packets PCKT1 storable in the retry buffer 6, there is a possibility that the buffer in which the packet PCKT0 is stored may not store some of the packets PCKT0. In a case where some of the packets PCKT0 are not stored, it is not possible to trace the eight packets PCKT1 stored in the retry buffer 6.

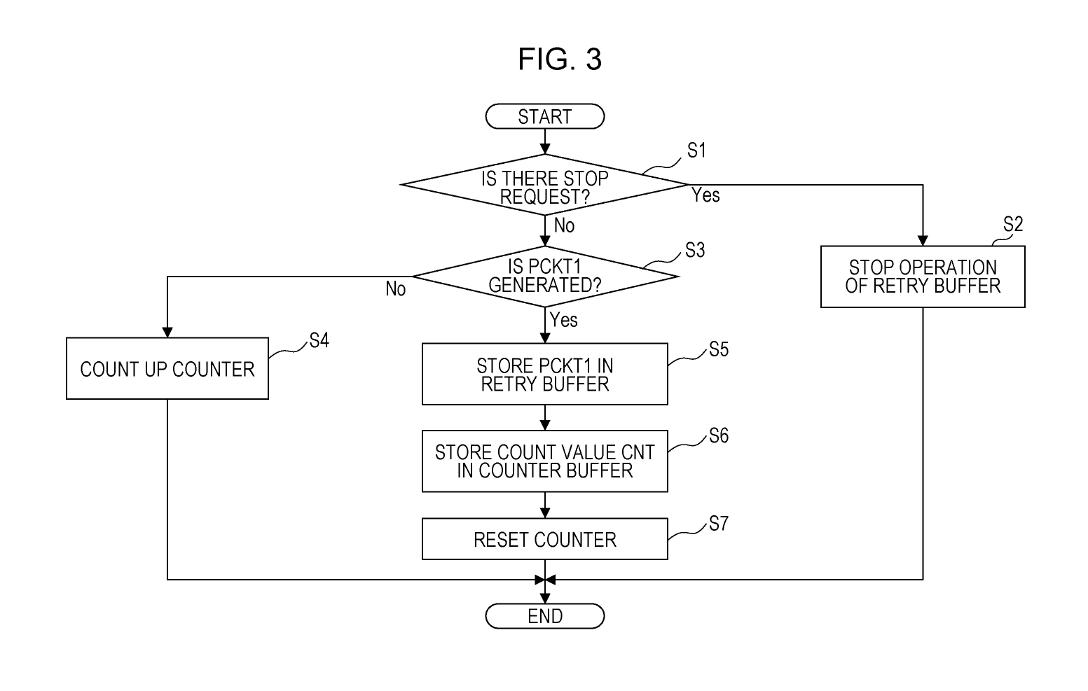

FIG. 3 illustrates an example of an operation flow of the memory controller 3 illustrated in FIG. 1. That is, FIG. 3 illustrates an example of a control method of a memory controller 30 and an example of the transmission information storage method. The flow illustrated in FIG. 3 is started based on a start of transmission of the packet PCKT to the memory 20 by the information processing device 100 and is repeatedly executed for each of clock cycles operating the memory controller 3. First, in step S1, in a case where a request to stop the operation of the retry buffer 6 occurs, the memory controller 30 moves the operation to step S2 and in a case where the request to stop the operation of the retry buffer 6 does not occur, the memory controller 30 moves the operation to step S3.

For example, in a case where the packets PCKT1 and PCKT0 transmitted to the memory 2 are traced, a control block (request to stop operation of retry buffer 6) inside or outside the memory controller 3 occurs. In step S2, the memory controller 3 stops the operation of the retry buffer 6 and ends the operation. In a case where the operation of the retry buffer 6 is stopped, the process in FIG. 3 is not repeated so that the packet generation circuit 4 stops to generate the packets PCKT1 and PCKT0. In step S3, the memory controller 3 determines whether or not the packet generation circuit 4 generates a new packet PCKT1.

In a case where the new packet PCKT1 is generated, the operation is moved to step S5. In a case where the new packet PCKT1 is not generated, the operation is moved to step S4 to generate the packet PCKT0. In step S4, the memory controller 3 counts up the counter 7 and ends the operation.

In step S5, the memory controller 3 stores the generated packet PCKT1 in one of the entries ENT of the retry buffer 6. Next, in step S6, the memory controller 3 stores the count value CNT in one of the entries ENT of the counter buffer 8. Next, in step S7, the memory controller 3 resets the counter 7 and sets the count value CNT to “0”, and the operation is ended. In the embodiment illustrated in FIGS. 1 and 2, by adding the counter 7 and the counter buffer 8 to the memory controller 3, it is possible to trace contents of the packets PCKT1 and PCKT0 transmitted to the memory 2.

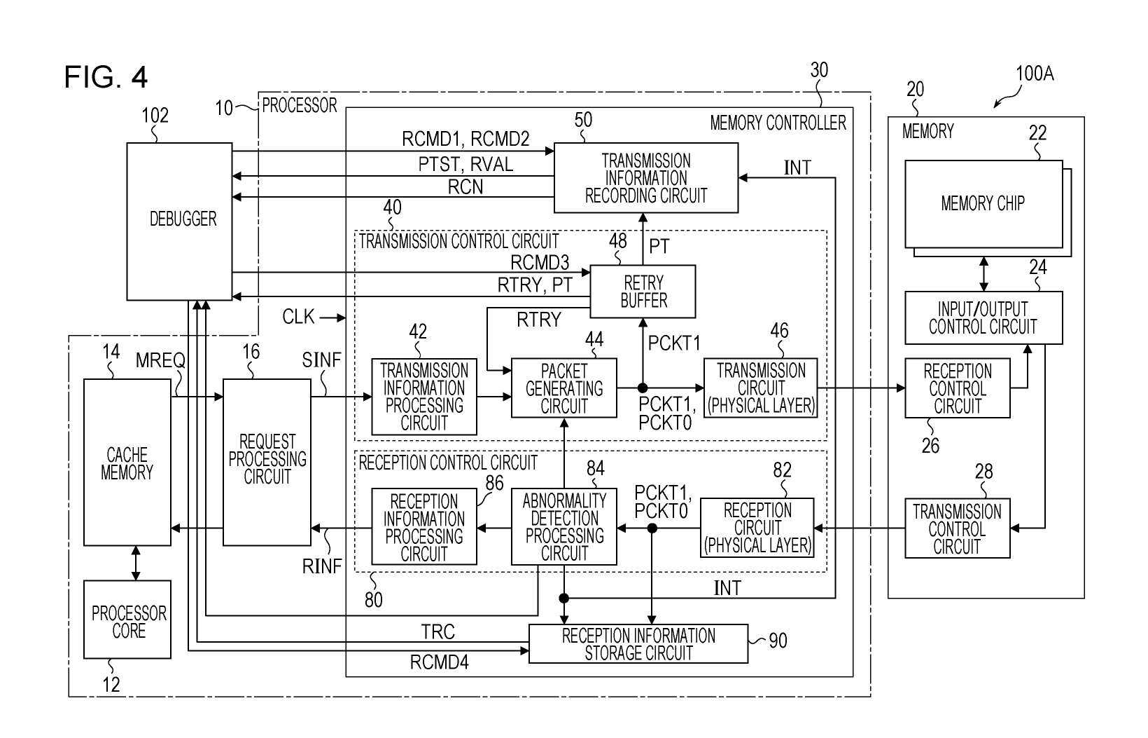

At this time, it is possible to decrease scale of a circuit used for tracing the packets PCKT1 and PCKT0 transmitted to the memory 2 as compared with a case where a buffer in which information itself included in the packet PCKT0 is stored is provided in the memory controller 3. FIG. 4 illustrates another embodiment of the information processing device, the processor, and the transmission information storage method. The same or similar elements as those described in the embodiment illustrated in FIG. 1 are denoted by the same reference numerals and a detailed description thereof will be omitted. An information processing device 100A illustrated in FIG. 4 includes a processor 10 which executes an operating process, the memory 20 such as a main memory unit which stores information, and a debugger 102.

The processor 10 includes a processor core 12 which executes an operating process, a cache memory 14, a request processing circuit 16, and the memory controller 30 which controls transmission and reception of packets to the memory 20.

For example, the cache memory 14 is a secondary cache.

In a case where cache miss occurs, the cache memory 14 issues the memory access request MREQ to the memory 20. In addition, the cache memory 14 stores data read from the memory 20 in response to the memory access request MREQ and outputs the data to the processor core 12. The request processing circuit 16 generates transmission information SINF based on the memory access request MREQ from the cache memory 14 and outputs the generated transmission information SINF to the memory controller 30. In addition, in a case where reception information RINF including data or the like is received from the memory controller 30, the request processing circuit 16 outputs the received reception information RINF in association with the transmission information SINF to the cache memory 14.

The memory controller 30 includes a transmission control circuit 40, a transmission information recording circuit 50, a reception control circuit 80, and a reception information storage circuit 90. The transmission control circuit 40 includes a transmission information processing circuit 42, a packet generation circuit 44, a transmission circuit 46, and a retry buffer 48. The reception control circuit 80 includes a reception circuit 82, an abnormality detection processing circuit 84, and a reception information processing circuit 86.

The transmission information processing circuit 42 includes a buffer in which the transmission information SINF received from the request processing circuit 16 in order is stored and outputs the transmission information SINF stored in the buffer to the packet generation circuit 44 in order. The packet generation circuit 44 generates the packet PCKT1 operating the memory 20 based on the transmission information SINF from the transmission information processing circuit 42. The packet PCKT1 is a packet which operates an inside circuit of the memory 20 such as a read request reading data from the memory 20, a write request writing the data in the memory 20, and a mode setting request setting an operation mode of the memory 20.

In addition, the packet generation circuit 44 generates the packet PCKT1 again transmitted to the memory 20 in the past based on retry information RTRY stored in the retry buffer 48. The packet PCKT1 is a logically valid packet for operating the memory 20. Further, the packet generation circuit 44 generates a packet PCKT0 indicating no-transmission of the packet PCKT1 since the packet PCKT1 is transmitted until the next packet PCKT1 is transmitted (for example, all of zeros). For example, a size of each of the packets PCKT1 and PCKT0 is 128 bits. The packet generation circuit 44 outputs information of a plurality of bits included in each of the generated packets PCKT (PCKT1 and PCKT0) in parallel. The packet PCKT1 is output to the transmission circuit 46 and the retry buffer 48. The packet PCKT0 is output to the transmission circuit 46. The packet generation circuit 44 is one example of an information generation circuit.

The transmission circuit 46 includes a transmission buffer, a serializer, an amplifier, and the like, converts parallel information included in the packet PCKT into serial data, amplifies a signal amplitude of the converted serial data, and transmits the data to the memory 20. For example, the transmission circuit 46 encodes the serial data by an 8b/10b method, a 64b/66b method, or the like and transmits the encoded serial data to the memory 20. The transmission circuit 46 is a circuit block corresponding to a physical layer for converting a bit string into an electric signal.

A frequency of a clock used by the transmission circuit 46 for transmitting the serial data is higher than a frequency of the clock CLK for operating the packet generation circuit 44 and the like. The transmission circuit 46 may transmit the serial data to the memory 20 by using a plurality of lanes which are data transmission lines. Since the packet PCKT0 does not operate the memory 20, the packet PCKT0 is logically invalid, but the packet PCKT0 has a physical meaning as an electric signal transmitted from the transmission circuit 46 to the memory 20. The retry buffer 48 includes a plurality of entries ENT and the buffer control circuit 6a in the same manner as the retry buffer 6 illustrated in FIG. 1.

The packet PCKT1 transmitted to the memory 20 is stored in each of the entries ENT as the retry information RTRY. The buffer control circuit 6a stores the packet PCKT1 generated by the packet generation circuit 44 in one of the plurality of the entries ENT as the retry information RTRY. The retry buffer 48 outputs the retry information RTRY or the pointer value PT stored in the entry ENT to the debugger 102 based on a read command RCMD3 output from the debugger 102.

The transmission information recording circuit 50 records information indicating the number of the packets PCKT0 transmitted to the memory 20 while the packet PCKT1 is not transmitted based on updating of the pointer value PT used by the retry buffer 48.

The transmission information recording circuit 50 outputs a count value RCN stored in the entry ENT to the debugger 102 based on a read command RCMD1 output from the debugger 102. In addition, the transmission information recording circuit 50 outputs information (PTST and RVAL) recorded in the transmission information recording circuit 50 to the debugger 102 based on a read command RCMD2 output from the debugger 102.

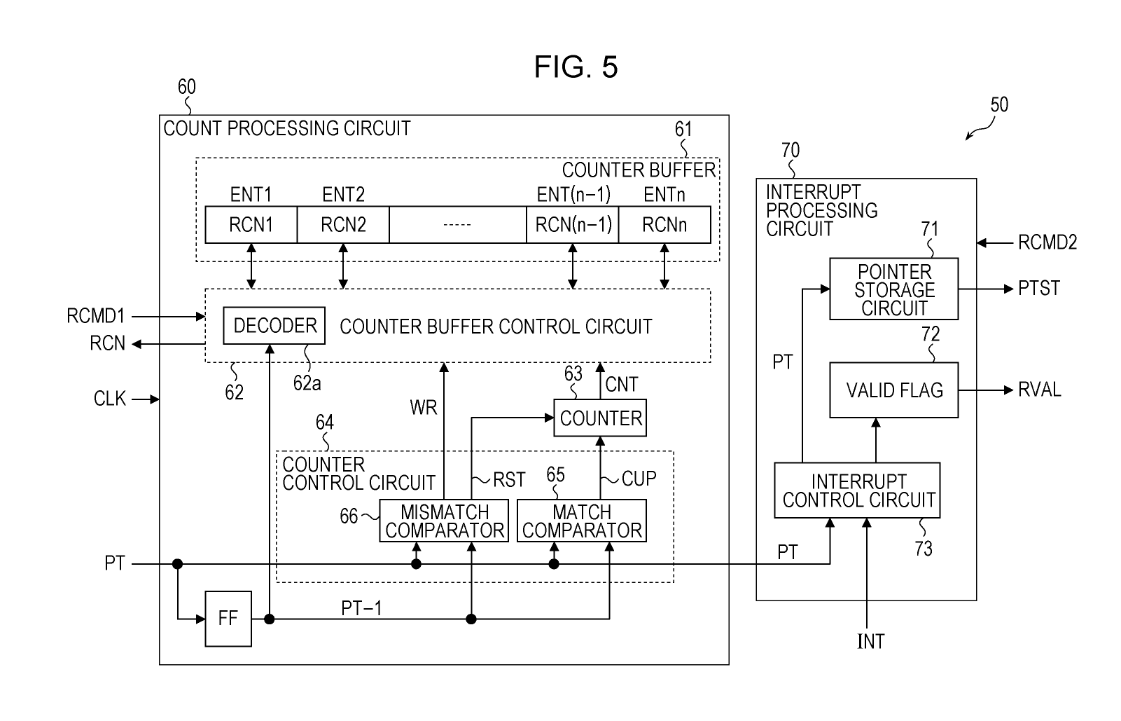

FIG. 5 illustrates an example of the transmission information recording circuit 50. The reception circuit 82 includes an equalizer such as a decision feedback equalizer (DFE), a deserializer, a clock data reproducing circuit, and the like. The equalizer compensates for a loss of a serial data signal transmitted from the memory 20. The deserializer converts the serial data signal output from the equalizer into a parallel data signal. The clock data reproducing circuit extracts a clock based on a transition edge of the data signal output from the deserializer, adjusts a phase of the clock, and outputs the clock to the DFE.

The reception circuit 82 outputs the parallel data information converted by the deserializer to the abnormality detection processing circuit 84 and the reception information storage circuit 90 as the packet PCKT (PCKT1 or PCKT0). The reception circuit 82 is a circuit block corresponding to a physical layer for converting an electric signal received from the memory 20 into a bit string. The reception circuit 82 may receive the serial data from the memory 20 by using a plurality of lanes which are data transmission lines. The abnormality detection processing circuit 84 detects the error response from the memory 20 or detects the presence or absence of abnormality of the information included in the packet PCKT1 received by the reception circuit 82 by a cyclic redundancy check (CRC) method or the like.

For example, in a case where the error response from the memory 20 is detected, the abnormality detection processing circuit 84 outputs an interrupt signal INT to the transmission information recording circuit 50 and the reception information storage circuit 90 and notifies the packet generation circuit 44 and the debugger 102 of occurrence of abnormality. In a case where abnormality is not detected, the abnormality detection processing circuit 84 outputs the packet PCKT1 received by the reception circuit 82 to the reception information processing circuit 86. The reception information processing circuit 86 obtains information included in the packet PCKT1 received from the reception circuit 82 via the abnormality detection processing circuit 84 and outputs the obtained information to the request processing circuit 16 as the reception information RINF. The reception information storage circuit 90 includes a plurality of entries and stores the packets PCKT1 and PCKT0 received from the memory 20 in one of the plurality of the entries in order.

The reception information storage circuit 90 outputs the packets PCKT1 and PCKT0 received from the memory 20 and stored in the plurality of the entries to the debugger 102 as trace information TRC based on a read command RCMD4 output from the debugger 102. The memory 20 includes a serial communication interface and is a storage device such as a hybrid memory cube (HMC) having a higher communication speed than an existing synchronous dynamic random access memory (SDRAM). For example, the memory 20 includes a plurality of stacked memory chips 22, an input/output control circuit 24, a reception control circuit 26, and a transmission control circuit 28.

The input/output control circuit 24 writes data in one of the memory chips 22 based on the information output from the reception control circuit 26 and outputs the data read from one of the memory chips 22 to the transmission control circuit 28. The reception control circuit 26 includes the same configuration as the reception control circuit 80 included in the memory controller 30 and is operated in the same manner as the reception control circuit 80. The transmission control circuit 28 includes the same configuration as the transmission control circuit 40 included in the memory controller 30 and is operated in the same manner as the transmission control circuit 40.

The debugger 102 outputs a read command RCMD (RCMD1, RCMD2, RCMD3, and RCMD4) to the memory controller 30 and reads information used for tracing the packet PCKT from the memory controller 30. The debugger 102 and the processor 10 are connected by an input/output interface such as an inter-integrated circuit (I²C: registered trademark) or a serial peripheral interface (SPI: registered trademark). The debugger 102 is one example of a trace circuit which traces the information transmitted to the memory 20. The debugger 102 may be provided in an outside of the information processing device 100A.

FIG. 5 illustrates an example of the transmission information recording circuit 50 illustrated in FIG. 4. The transmission information recording circuit 50 includes a count processing circuit 60 and an interrupt processing circuit 70. The count processing circuit 60 includes a counter buffer 61, a counter buffer control circuit 62, a counter 63, a counter control circuit 64, and a flip flop FF. The counter control circuit 64 includes a match comparator 65 and a mismatch comparator 66. The interrupt processing circuit 70 includes a pointer storage circuit 71, a valid flag 72, and an interrupt control circuit 73.

The transmission information recording circuit 50 is operated in synchronization with the clock CLK. The counter buffer 61 includes n entries ENT (ENT1 to ENTn) corresponding to the n entries ENT (ENT1 to ENTn) included in the retry buffer 48. The flip flop FF delays the pointer value PT received in synchronization with the clock CLK by one clock cycle, so that the flip flop FF outputs the pointer value PT−1 as the pointer value PT.

In a case where the pointer value PT of the retry buffer 48 matches the pointer value PT−1, which is a pointer value PT before one clock cycle, output from the flip flop FF, the match comparator 65 outputs a counting up signal CUP for each of the clock cycles to the counter 63. In a case where the pointer value PT of the retry buffer 48 does not match the pointer value PT−1, the mismatch comparator 66 outputs a reset signal RST to the counter 63 and outputs a write signal WR to the counter buffer control circuit 62. The counter 63 resets the count value to “0” based on the reset signal RST output from the mismatch comparator 66 and increases the count value by “1” based on the counting up signal CUP output from the match comparator 65.

The count value counted by the counter 63 stops at a maximum value without wrap around after reaching the maximum value. The counter buffer control circuit 62 includes a decoder 62a which detects the entry ENT indicated by the pointer value PT−1 output from the flip flop FF. The counter buffer control circuit 62 stores the count value CNT counted by the counter 63 in the entry ENT detected by the decoder 62a as the count value RCN (RCN1 to RCNn) based on the write signal WR output from the counter control circuit 64.

In addition, the counter buffer control circuit 62 reads the count value RCN from the entry ENT designated by the read command RCMD1 based on the read command RCMD1 from the debugger 102 and outputs the read count value RCN to the debugger 102. The counter buffer control circuit 62 may output the count values RCN1 to RCNn stored in all of the entries ENT1 to ENTn to the debugger 102 based on the read command RCMD1. The interrupt control circuit 73 of the interrupt processing circuit 70 stores the pointer value PT of the retry buffer 48 in the pointer storage circuit 71 as the pointer value PTST based on the interrupt signal INT and sets the valid flag 72 to “1”.

In a case where the pointer value PT of the retry buffer 48 makes one round and matches the pointer value PTST stored in the pointer storage circuit 71, the interrupt control circuit 73 resets the valid flag 72 to “0”. In addition, the interrupt control circuit 73 outputs the pointer value PTST stored in the pointer storage circuit 71 and the flag value RVAL which is a value of the valid flag 72 to the debugger 102 based on the read command RCMD2 from the debugger 102. The interrupt control circuit 73 is an example of a pointer control circuit which stores the pointer value PT in the pointer storage circuit 71 based on the error response from the memory 20 for the packet PCKT1 transmitted to the memory 20.

The pointer storage circuit 71 stores the pointer value PT output from the interrupt control circuit 73 as the pointer value PTST and outputs the stored pointer value PTST. In a case where the pointer value PTST stored in the pointer storage circuit 71 is valid, the valid flag 72 is set to “1” indicating a valid state. In a case where the pointer value PTST is invalid, the valid flag 72 is set to “0” indicating an invalid state. The pointer storage circuit 71 is an example of a pointer memory in which the pointer value PT is stored and the valid flag 72 is an example of a flag indicating whether the pointer value PT stored in the pointer storage circuit 71 is valid or invalid.

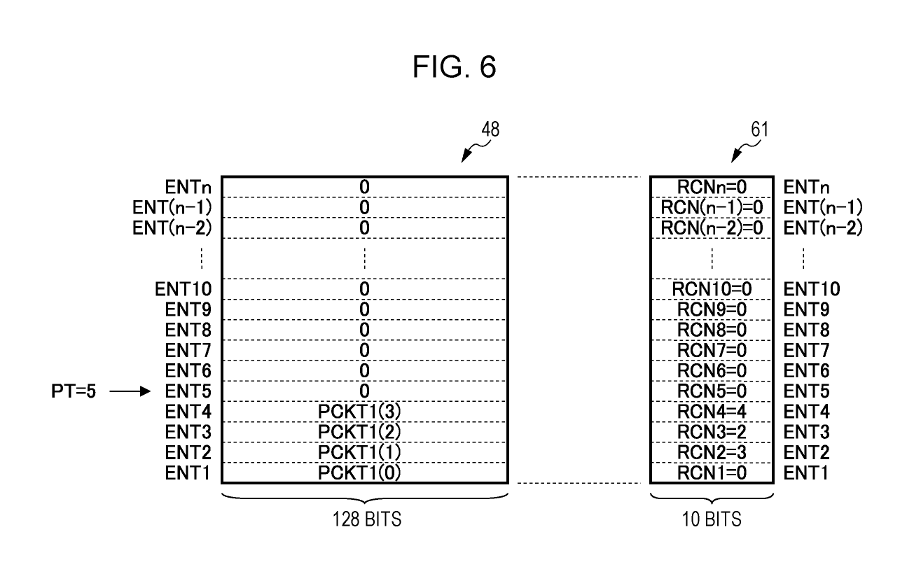

FIG. 6 illustrates an example of a relationship between the entry ENT of the retry buffer 48 illustrated in FIG. 4 and the entry ENT of the counter buffer 61 illustrated in FIG. 5. The retry buffer 48 includes the n entries ENT stored in the packet PCKT1 and the counter buffer 61 includes the n entries ENT stored in the count value RCN. As illustrated in FIG. 6, each of the entries ENT of the counter buffer 61 is provided to be corresponded to each of the entries ENT of the retry buffer 48.

The entries ENT of the retry buffer 48 are examples of the first storage region and the entries ENT of the counter buffer 61 are examples of the second control circuit. The counter buffer control circuit 62 is an example of the second control circuit. A size of each of the retry buffer 48 is 128 bits in the same manner as the packet PCKT1.

By setting each of the entries ENT of the counter buffer 61 to 10 bits, the counter buffer 61 can store up to the count value RCN corresponding to the 1023 packets PCKT0. As illustrated in FIG. 6, information stored in the entries ENT1 to ENT4 of the retry buffer 48 and the entries ENT1 to ENT4 of the counter buffer 61 is the same as information illustrated in FIG. 2 and the pointer value PT is “5”. The entries ENT1 to ENTn of the retry buffer 48 and the entries ENT1 to ENTn of the counter buffer 61 are cleared to all zeroes in the initial state.

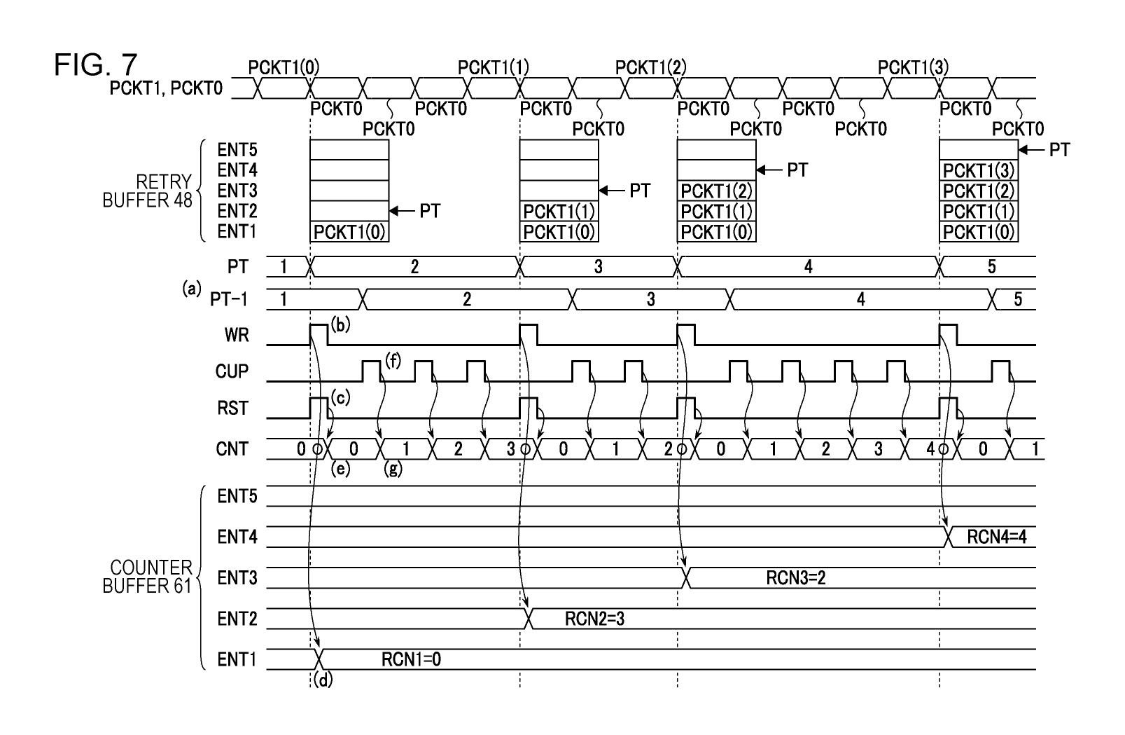

FIG. 7 illustrates an example of an operation of the memory controller 30 illustrated in FIG. 4. That is, FIG. 7 illustrates an example of the transmission information storage method and an example of the control method of the memory controller 30. A detailed explanation for the same operation as FIG. 2 will be omitted.

The packets PCKT1 and PCKT0 transmitted from the memory controller 30 to the memory 20 are the same as FIG. 2 and the packet PCKT1 stored in the retry buffer 48 and the count value CNT stored in the counter buffer 61 illustrated in FIG. 7 are the same as those illustrated in FIGS. 2 and 7.

One of the packets PCKT1 and PCKT0 is transmitted to the memory 20 for each of the clock cycles. The flip flop FF illustrated in FIG. 5 generates the pointer value PT−1 by delaying the pointer value PT by one clock cycle ((a) in FIG. 7). The mismatch comparator 66 illustrated in FIG. 5 outputs the write signal WR in a pulse shape and the reset signal RST in a pulse shape during the clock cycles during which the pointer values PT and PT−1 are different from each other ((b) and (c) in FIG. 7).

The counter buffer control circuit 62 illustrated in FIG. 5 stores the count value CNT counted by the counter 63 illustrated in FIG. 5 in the entry ENT1 of the counter buffer 61 indicated by the pointer value PT−1 in synchronization with a rising edge of the write signal WR ((d) in FIG. 7). After then, the counter 63 is set to “0” in synchronization with a falling edge of the reset signal RST ((e) in FIG. 7).

The match comparator 65 illustrated in FIG. 5 outputs the counting up signal CUP in a pulse shape during the clock cycles during which the pointer values PT and PT−1 are equal to each other ((f) in FIG. 7). The counter 63 increases the count value CNT by “1” in synchronization with a falling edge of the counting up signal CUP ((g) in FIG. 7).

The mismatch comparator 66 resets the count value CNT and the match comparator 65 increases the count value CNT, so that it is possible to count the number of the generated packets PCKT0 without directly detecting the packet PCKT0. By repeating the operation described above, the states of the retry buffer 48 and the counter buffer 61 are in the state illustrated in FIG. 6. That is, the same operation as FIG. 2 is executed.

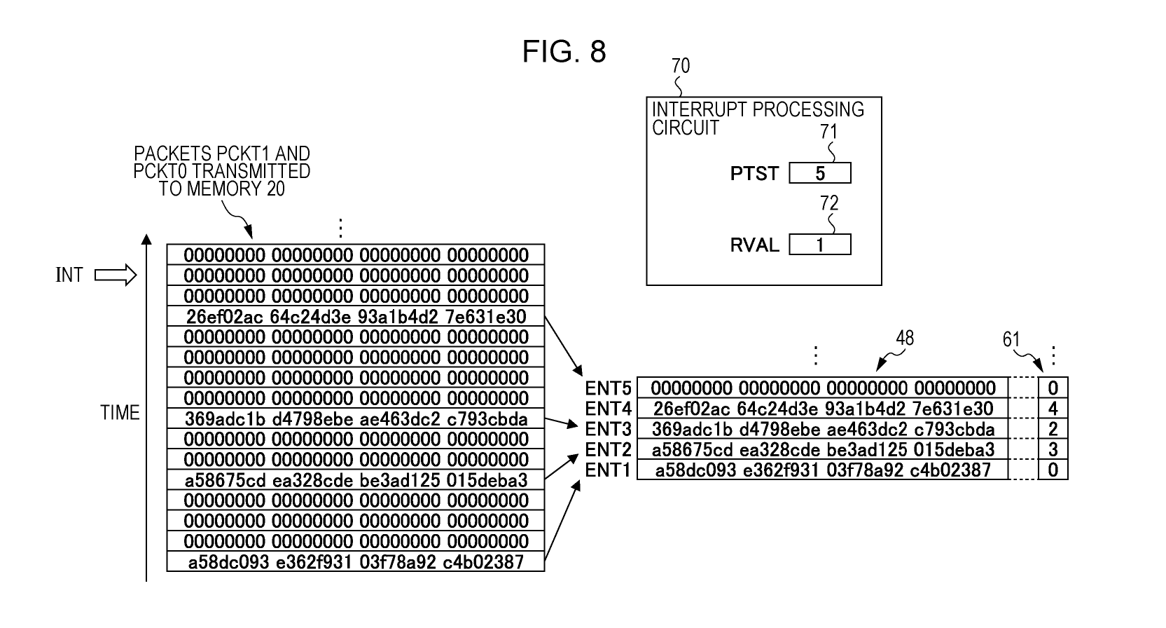

FIG. 8 illustrates an example of a state of the interrupt processing circuit 70 in a case where the interrupt signal INT occurs in the information processing device 100A illustrated in FIG. 4. In FIG. 8, after the operation illustrated in FIG. 7 is executed, for example, the abnormality detection processing circuit 84 illustrated in FIG. 4 detects the error response from the memory 20 and generates the interrupt signal INT. The packet PCKT transmitted to the memory 20 illustrated on a left side of FIG. 8 indicates the packet PCKT transmitted to the memory 20 by the operation in FIG. 7 in hexadecimal notation. All of zeros indicate the packet PCKT0 and other numbers other than all of the zeros indicate the packet PCKT1.

The lower packet PCKT has a shorter transmission time.

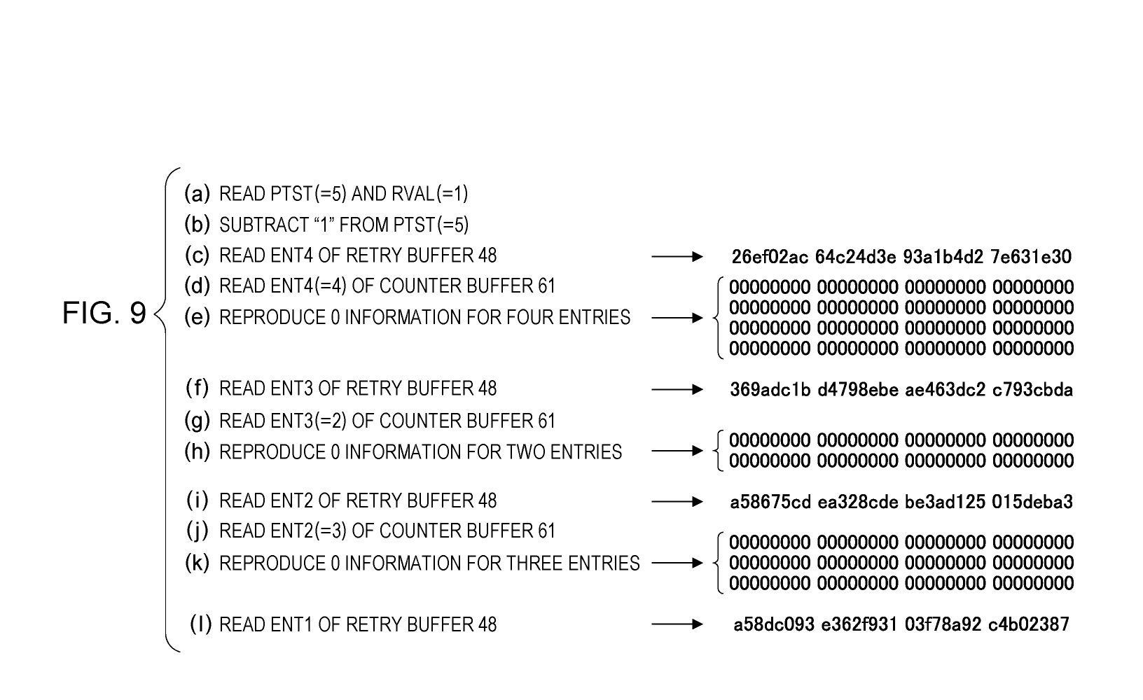

The interrupt processing circuit 70 illustrated in FIG. 5 stores the pointer value PT (=5) of the retry buffer 48 in the pointer storage circuit 71 as the pointer value PTST based on the interrupt signal INT and sets the flag value RVAL of the valid flag 72 to “1”. FIG. 9 illustrates an example of an operation of tracing the packets PCKT1 and PCKT0 transmitted to the memory 20 by the debugger 102 in the information processing device 100A illustrated in FIG. 4. For example, after the abnormality detection processing circuit 84 outputs the interrupt signal INT, the debugger 102 starts to trace the packets PCKT1 and PCKT0 transmitted to the memory 20 based on an instruction of a terminal device which controls the information processing device 100A.

The terminal device or the like is operated by an operator of the information processing device 100A. First, the debugger 102 outputs the read command RCMD2 to the interrupt processing circuit 70 and reads the pointer value PTST and the flag value RVAL. Since the flag value RVAL is “1”, the debugger 102 determines that the pointer value PTST is valid ((a) in FIG. 9). The debugger 102 subtracts “1” from the pointer value PTST and calculates a number (=4) of the entry ENT of the retry buffer 48 in which the latest packet PCKT1 among the packets PCKT1 to be traced is stored ((b) in FIG. 9).

Next, the debugger 102 outputs the read command RCMD3 to the retry buffer 48 and reads the retry information RTRY (that is, packet PCKT1) stored in the entry ENT4 of the retry buffer 48 ((c) in FIG. 9).

Next, the debugger 102 outputs the read command RCMD1 to the count processing circuit 60 and reads the count value (=4) stored in the entry ENT4 of the counter buffer 61 ((d) in FIG. 9). The debugger 102 reproduces the packet PCKT0 for the four entries corresponding to the read count value ((e) in FIG. 9).

Next, the debugger 102 outputs the read command RCMD3 to the retry buffer 48 and reads the retry information RTRY stored in the entry ENT3 of the retry buffer 48 ((f) in FIG. 9).

Next, the debugger 102 outputs the read command RCMD1 to the count processing circuit 60 and reads the count value (=2) stored in the entry ENT3 of the counter buffer 61 ((g) in FIG. 9). The debugger 102 reproduces the packet PCKT0 for the two entries corresponding to the read count value ((h) in FIG. 9). The debugger 102 repeats the same operation as described above to trace the packets PCKT1 and PCKT0 transmitted to the memory 20 ((i) to (l) in FIG. 9).

As illustrated above, it is possible for the debugger 102 to trace the packet PCKT1 stored in the retry buffer 48 until the interrupt signal INT is output and the packet PCKT0 transmitted between the two packets PCKT1 adjacent to each other. For example, the retry buffer 48 includes the 512 entries ENT of 128 bits and the counter buffer 61 includes the 512 entries ENT of 10 bits. In this case, a capacity of the entry ENT of the retry buffer 48 is 65536 bits, a capacity of the entry ENT of the counter buffer 61 is 5120 bits, and a total capacity is 70656 bits.

One entry ENT of the counter buffer 61 can store information corresponding to the 1023 packets PCKT0. Therefore, the debugger 102 can trace up to the 512 packets PCKT1 and the 522753 (1023×511) packets PCKT0. For example, an average of the number of the packets PCKT0 transmitted to the memory 20 since the packet PCKT1 is transmitted until the next packet PCKT1 is transmitted is 20.

In this case, the 10220 (511×20) packets PCKT0 is transmitted to the memory 20 for the 512 packets PCKT1. In a case where the packet PCKT0 of 128 bits is stored in the buffer or the like as it is, a capacity of the buffer in which the 10220 packets PCKT0 are stored is 1277500 (10220×128) bits. By providing the counter buffer 61 illustrated in FIG. 5, it is possible to reduce 1277500 bits to 70656 bits.

As a result, a mounting area of the memory controller 30 can be reduced as compared with a case where the packet PCKT0 of 128 bits is stored in the buffer or the like as it is. In FIG. 9, it is not possible to trace the packet PCKT0 transmitted to the memory 20 after the packet PCKT1 stored in the entry ENT4 is transmitted.

For example, by providing a count value storage circuit, which stores the count value CNT when the interrupt signal INT occurs, in the interrupt processing circuit illustrated in FIG. 5, it is possible to exactly trace the packet PCKT0 at a time when the interrupt signal INT occurs.

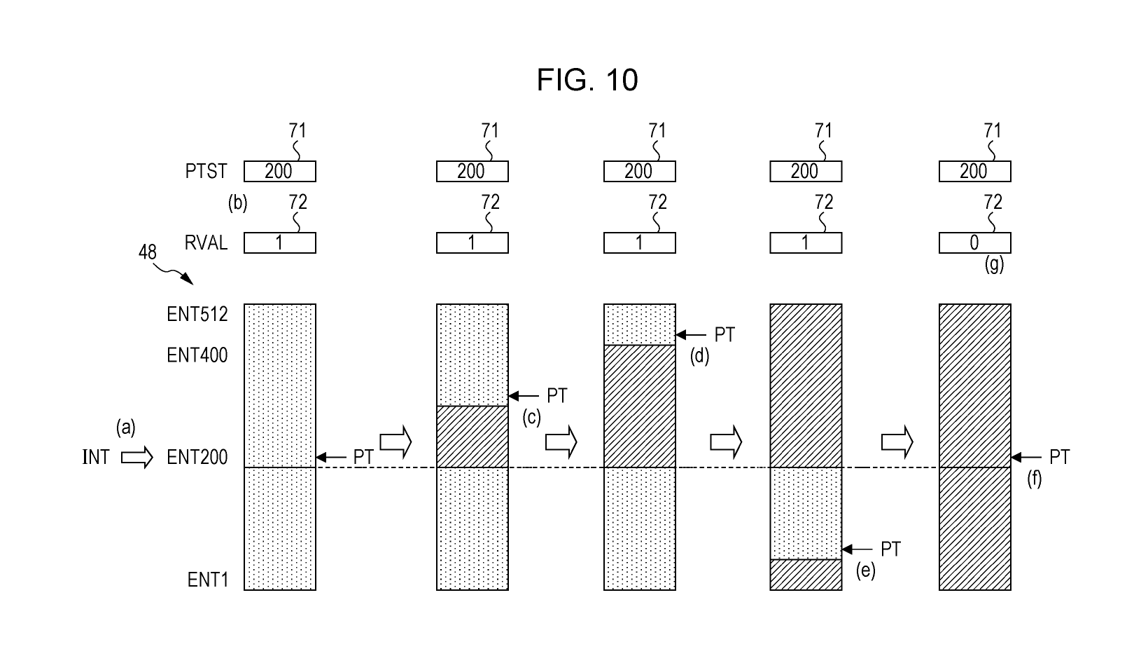

FIG. 10 illustrates an example of a state of the interrupt processing circuit 70 after the interrupt signal INT occurs in the information processing device 100A illustrated in FIG. 4. As illustrated in FIG. 10, the retry buffer 48 includes the 512 entries ENT1 to ENT512 and the traceable and valid packets PCKT1 are stored in the entries ENT200 to ENT512 and ENT1 to ENT199 indicated by shading. Here, the memory controller 30 already transmits the packet PCKT1 to the memory 20 in order stored in the entries ENT200-ENT512 and ENT1-ENT199. That is, among the packets PCKT1 stored in the entry ENT1-ENT512, a transmission time of the packet PCKT1 stored in the entry ENT200 is the earliest and a transmission time of the packet PCKT1 stored in the entry ENT199 is the latest.

As illustrated in FIG. 10, the interrupt signal INT occurs when the pointer value PT is 200 ((a) in FIG. 10). The interrupt processing circuit 70 illustrated in FIG. 5 stores the pointer value PTST (=200) in the pointer storage circuit 71 based on occurrence of the interrupt signal INT and sets the flag value RVAL to “1” ((b) in FIG. 10).

For example, even in a case of receiving abnormality notification from the abnormality detection processing circuit 84 (that is, interrupt signal INT is issued), the packet generation circuit 44 illustrated in FIG. 4 does not stop to generate the packets PCKT1 and PCKT0.

In this case, as indicated by the hatched frame, the packet PCKT1 is overwritten in the entries ENT of the retry buffer 48 in order ((c), (d), and (e) in FIG. 10). By storing the pointer value PT in the pointer storage circuit 71 as the pointer value PTST when the interrupt signal INT occurs, even in a case where the packet PCKT is generated after the interrupt signal INT occurs, it is possible to store the pointer value PT when the interrupt signal INT occurs.

Therefore, even in a case where the newly generated packet PCKT1 is stored in the retry buffer 48 and the pointer value PT is updated, it is also possible to reduce a loss of the pointer value PT when the interrupt signal INT occurs.

In a case where the pointer value PT makes one round and becomes “200”, all of the valid packet PCKT1 indicated by shading are overwritten by the new packet PCKT1, generated after the interrupt signal INT occurs, to be transmitted to the memory 20 ((f) in FIG. 10). Since it is not possible to trace the packet PCKT1 transmitted to the memory 20 before the interrupt signal INT occurs, the interrupt processing circuit 70 sets the flag value RVAL to “0” ((g) in FIG. 10).

In a case where the flag value RVAL read from the interrupt processing circuit 70 is “0”, the debugger 102 determines that the retry buffer 48 does not store the valid packet PCKT1 and does not trace the packets PCKT1 and PCKT0.

On the other hand, in a case where the flag value RVAL is “1”, the debugger 102 can trace the packets PCKT1 and PCKT0 transmitted to the memory 20 by using the packet PCKT1 stored in the entry ENT of the retry buffer 48. Here, the packet PCKT1 used for tracing is the packet PCKT1 stored from the entry ENT indicated by the preceding value of the pointer value PTST by one to the entry ENT indicated by the pointer value PT.

In a case where the packet generation circuit 44 stops to generate the packets PCKT1 and PCKT0 based on notification of abnormality from the abnormality detection processing circuit 84, the retry buffer 48 is maintained in the state illustrated on the leftmost side of FIG. 10. In this case, since the pointer value PT may be not retreated as the pointer value PTST, the memory controller 30 includes the transmission information recording circuit 50 without the interrupt processing circuit 70 illustrated in FIG. 5.

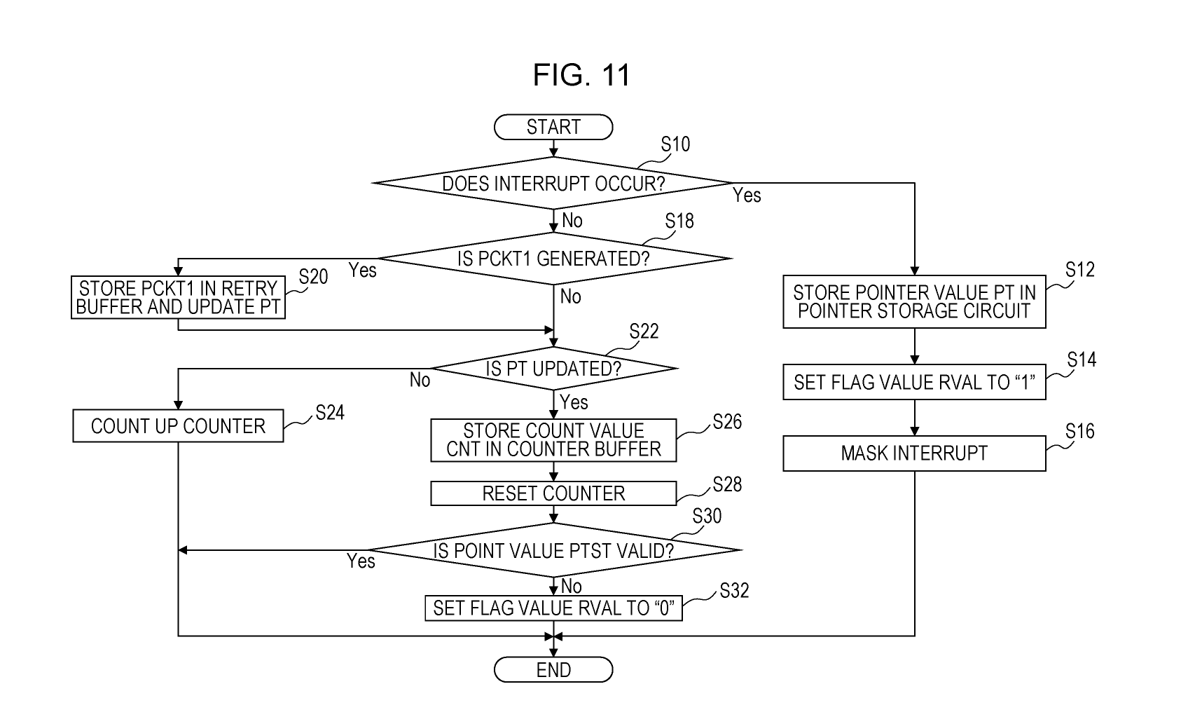

FIG. 11 illustrates an example of an operation flow of the transmission information recording circuit 50 illustrated in FIG. 5. That is, FIG. 11 illustrates an example of the transmission information storage method and an example of the control method of the memory controller 30. The flow illustrated in FIG. 11 is started based on a start of transmission of the packet PCKT to the memory 20 by the information processing device 100A and is repeatedly executed for each of clock cycles. First, in step S10, in a case where the interrupt signal INT occurs, the memory controller 30 moves the operation to step S12 and in a case where the interrupt signal INT does not occur, the memory controller 30 moves the operation to step S18. In step S12, the interrupt processing circuit 70 stores the pointer value PT in the pointer storage circuit 71 as the pointer value PTST.

Next, in step S14, the interrupt processing circuit 70 sets the flag value RVAL to “1”.

Next, in step S16, the abnormality detection processing circuit 84 masks issuance of the interrupt signal INT.

By masking the issuance of the interrupt signal INT, it is possible to inhibit the pointer value PT stored in the pointer storage circuit 71 from being written by the newly generated interrupt signal INT.

The operation in step S16 may be executed before the operation in step S12 or S14. In step S18, in a case where the new packet PCKT1 is generated, the retry buffer 48 moves the operation to step S20. In a case where the new packet PCKT1 is not generated, the retry buffer 48 moves the operation to step S22.

In step S20, the retry buffer 48 stores the newly generated packet PCKT1 in one of the entries ENT as the retry information RTRY and updates the pointer PT.

After step S20, the operation is moved to step S22.

In step S22, the count processing circuit 60 determines whether or not the pointer value PT is updated.

That is, the count processing circuit 60 determines whether or not the new packet PCKT1 to be transmitted to the memory 20 is generated and the new packet PCKT1 is stored in the retry buffer 48.

In a case where the new packet PCKT1 is generated and the pointer value PT is updated, the operation is moved to step S26. In a case where the new packet PCKT1 is not generated and the pointer value PT is not updated, the operation is moved to step S24.

In step S24, the count processing circuit 60 counts up the counter 63 and ends the operation.

In step S26, the count processing circuit 60 stores the count value CNT in one of the entries ENT of the counter buffer 61 as the count value RCN.

Next, in step S28, the count processing circuit 60 resets the counter 63 and sets the count value CNT to “0”.

Next, in step S30, the interrupt processing circuit 70 determines whether or not the pointer value PT makes one round and reaches the pointer value PTST.

In a case where the pointer value PT does not reach the pointer value PTST, the interrupt processing circuit 70 determines that the pointer value PTST is valid and ends the operation. On the other hand, in a case where the pointer value PT makes one round and reaches the pointer value PTST, the interrupt processing circuit 70 determines that the pointer value PTST is invalid and moves the operation to step S32.

In step S32, since the pointer value PTST becomes invalid, the interrupt processing circuit 70 sets the flag value RVAL to “0” and ends the operation.

In a case where the packet generation circuit 44 stops to generate the packets PCKT1 and PCKT0 based on occurrence of the interrupt signal INT or the like, the memory controller 30 does not have the interrupt processing circuit 70.

In this case, the processes in steps S12, S14, S30, and S32 in FIG. 11 are deleted and the operation is ended after step S28 is executed. Even in the embodiments illustrated in FIGS. 4 to 11, the same effects as embodiments illustrated in FIGS. 1 to 3 also can be obtained. That is, it is possible to decrease scale of a circuit used for tracing the packets PCKT1 and PCKT0 transmitted to the memory 20 as compared with a case where a buffer in which information itself included in the packet PCKT0 is stored is provided in the memory controller 30. Further, in the embodiments illustrated in FIGS. 4 to 11, the following effects can be obtained. That is, the mismatch comparator 66 resets the count value CNT and the match comparator 65 increases the count value CNT, so that it is possible to count the number of the generated packets PCKT0 without directly detecting the packet PCKT0.

By providing the pointer storage circuit 71, even in a case where the packet PCKT is continued to be generated after the interrupt signal INT occurs, it is possible to store the pointer value PT when the interrupt signal INT occurs without a loss. Further, by providing the valid flag 72, even in a case where the packet PCKT is continued to be generated after the interrupt signal INT occurs, it is possible to determine whether or not the valid packet PCKT1 to be traced is stored in the retry buffer 48. By providing the debugger 102 in the information processing device 100A, it is possible to trace the packet PCKT transmitted to the memory 20 based on the packet PCKT1 stored in the retry buffer 48 and the count value RCN stored in the counter buffer 61. By the abnormality detection processing circuit 84 masking the issuance of the interrupt signal INT, it is possible to inhibit the pointer value PT stored in the pointer storage circuit 71 from being written by the newly generated interrupt signal INT. As a result, it is possible to reduce malfunction of the memory controller 30.

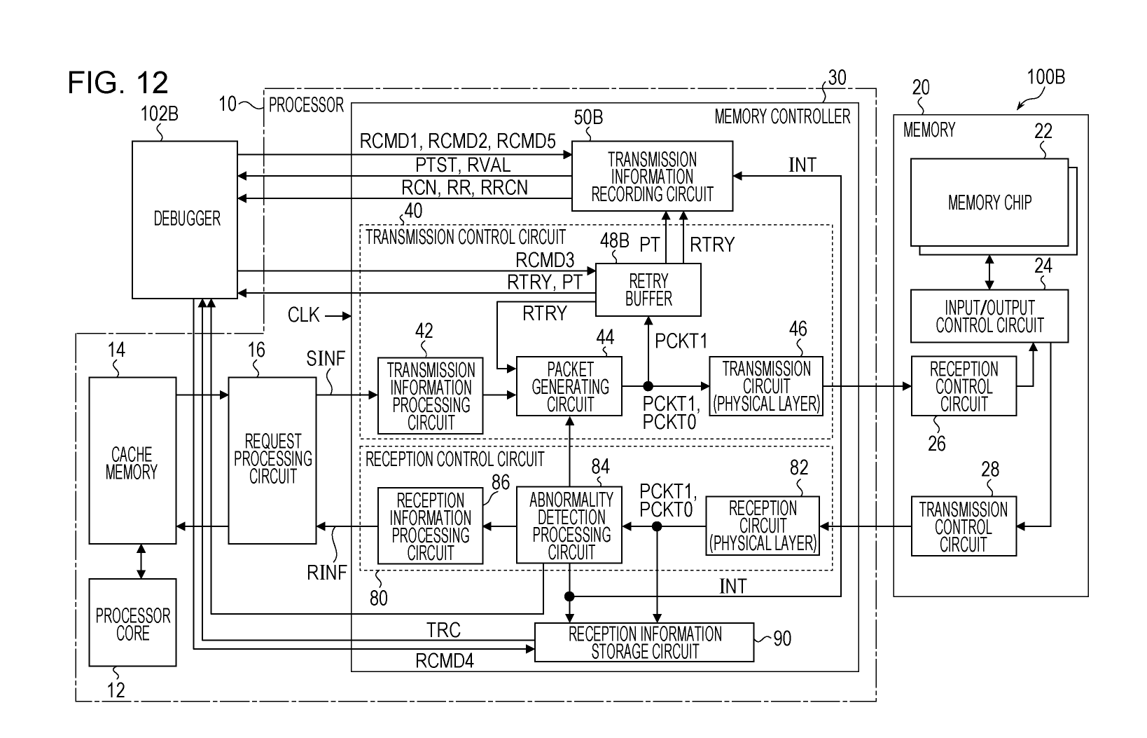

FIG. 12 illustrates still another embodiment of the information processing device, the processor, and the transmission information storage method. The same or similar elements as those described in the embodiments illustrated in FIGS. 1 to 11 are denoted by the same reference numerals and a detailed description thereof will be omitted. An information processing device 100B illustrated in FIG. 12 includes a retry buffer 48B, a transmission information recording circuit 50B, and a debugger 102B instead of the retry buffer 48, the transmission information recording circuit 50, and the debugger 102 illustrated in FIG. 4.

A configuration of the information processing device 100B without the retry buffer 48B, the transmission information recording circuit 50B, and the debugger 102B is the same as the information processing device 100A illustrated in FIG. 3. In addition to the function of the retry buffer 48 illustrated in FIG. 4, the retry buffer 48 B has a function of outputting the retry information RTRY (that is, packet PCKT1) stored in one of the entries ENT to the transmission information recording circuit 50B. The transmission information recording circuit 50B has a function of storing the retry information RTRY output from the retry buffer 48B in association with the count value RCN.

In addition, the transmission information recording circuit 50B has a function of outputting the stored retry information RTRY and count value RCN to the debugger 102B as retry information RR and a count value RRCN based on a read command RCMD5. Other functions of the transmission information recording circuit 50B are the same as the functions of the transmission information recording circuit 50 illustrated in FIG. 4. The debugger 102B has a function of outputting the read command RCMD5 and a function of receiving the retry information RR and the count value RRCN output from the memory controller 30 in response to the read command RCMD5 in addition to the functions of the debugger 102 illustrated in FIG. 4. The debugger 102B is one example of a trace circuit which traces the information transmitted to the memory 20.

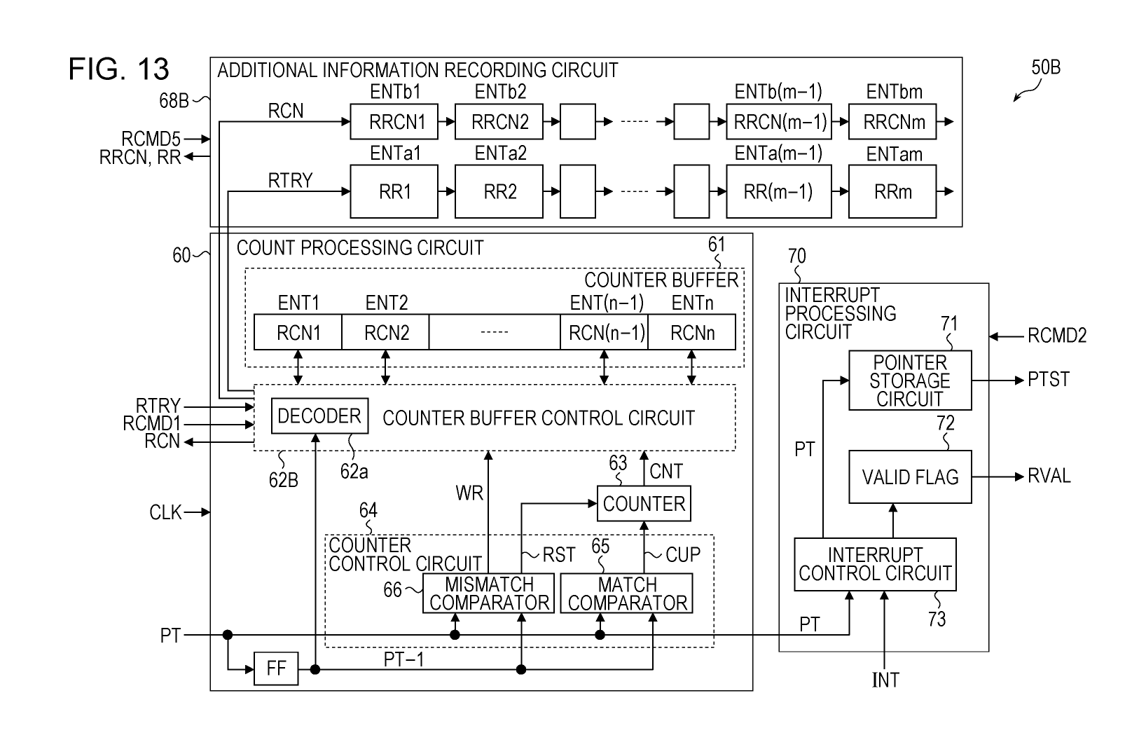

FIG. 13 illustrates an example of the transmission information recording circuit 50B illustrated in FIG. 12. The same or similar elements as the transmission information recording circuit 50 illustrated in FIG. 5 are denoted by the same reference numerals and a detailed description thereof will be omitted.

The transmission information recording circuit 50B includes the count processing circuit 60, the interrupt processing circuit 70, and an additional information recording circuit 68B. The count processing circuit 60 includes a counter buffer control circuit 62B instead of the counter buffer control circuit 62 illustrated in FIG. 5. Other functions of the count processing circuit 60 are the same as the functions of the count processing circuit 60 illustrated in FIG. 5.

The counter buffer control circuit 62B has a function of outputting the retry information RTRY received from the retry buffer 48B illustrated in FIG. 12 with one of the count values RCN stored in the counter buffer 61 to the additional information recording circuit 68B. Other functions of the counter buffer control circuit 62B are the same as the functions of the counter buffer control circuit 62 illustrated in FIG. 5. The counter buffer control circuit 62B is an example of a third control circuit.

The additional information recording circuit 68B includes the m entries ENTa (ENTa1 to ENTam) in which the retry information RTRY is stored and the m entries ENT (ENTb1 to ENTbm) in which the count value RCN transmitted from the counter buffer 61 is stored. Each of the entries ENTa1 to ENTam corresponds to each of the entries ENTb1 to ENTbm. Each of the entries ENTa is an example of a third storage region and each of the entries ENTb is an example of a fourth storage region.

Each of the entries ENTa1 to ENTam has a configuration of a shift register. The retry information RTRY stored in the entry ENTa1 of a first stage is transmitted toward the entry ENTa of the next stage in order whenever the new retry information RTRY is received. The retry information RTRY stored in the entry ENTam of the last stage is expelled from the entry ENTam based on reception of the new retry information RTRY. Hereinafter, the retry information RTRY stored in the entry ENT (entries ENTa1 to ENTam) is referred to as “retry information RR (RR1 to RRm)”. Each of the entries ENTb1 to ENTbm has a configuration of a shift register. The count value RCN stored in the entry ENTb1 of a first stage is transmitted toward the entry ENTb of the next stage in order whenever the new count value RCN is received.

The count value RCN stored in the entry ENTbm of the last stage is expelled from the entry ENTbm based on reception of the new count value RCN. Hereinafter, the count value RCN stored in the entry ENT (entries ENTb1 to ENTbm) is referred to as “count value RRCN (RRCN1 to RRCNm)”. The additional information recording circuit 68B outputs the retry information RR stored in the entry ENTa and the count value RRCN stored in the entry ENTb to the debugger 102B based on the read command RCMD5 received from the debugger 102B.

For example, the additional information recording circuit 68B outputs the retry information RR1 to RRm and the count value RCN1 to RCNm to the debugger 102B based on the read command RCMD5. In a case where the read command RCMD5 includes an entry number, the additional information recording circuit 68B may output the retry information RR and the count value RRCN stored in the designated entries ENTa and ENTb to the debugger 102B.

In addition, the entries ENTa and ENTb may have the same configuration of the ring buffer managed by the pointer value PT as the retry buffer 48 illustrated in FIG. 6.

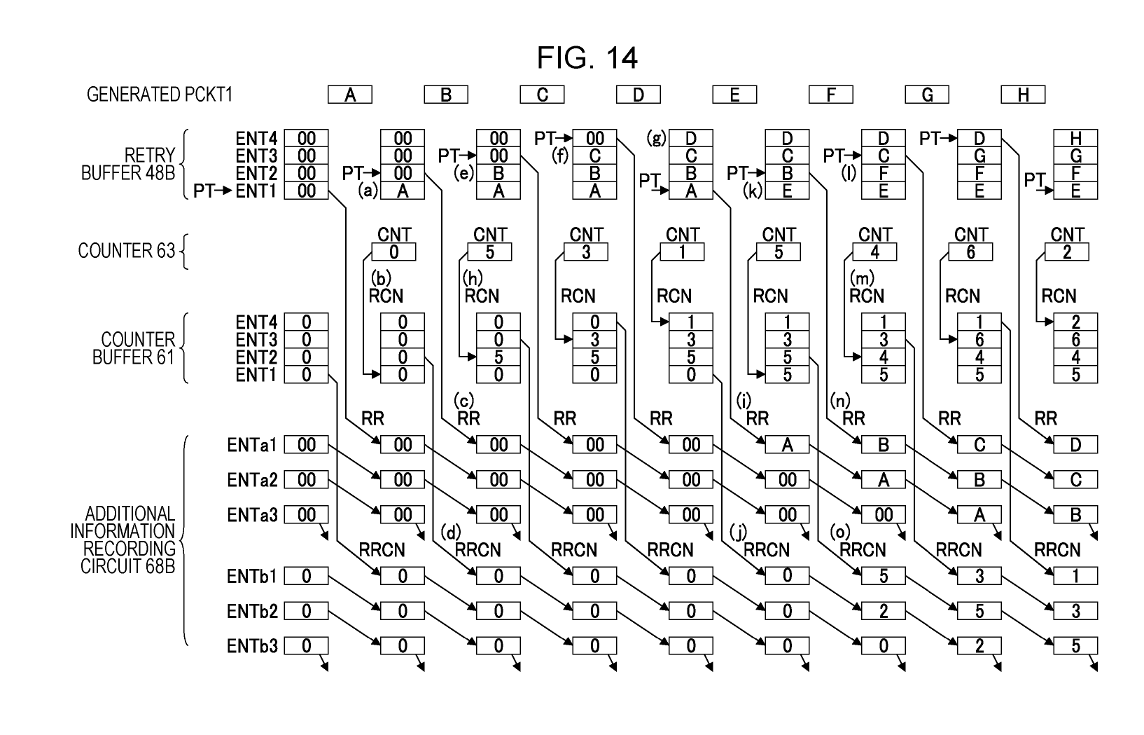

FIG. 14 illustrates an example of an operation of the memory controller 30 illustrated in FIG. 12. FIG. 14 illustrates an example in which the packet PCKT1 generated by the packet generation circuit 44 is stored in the retry buffer 48B in order in an initial state in which the packet PCKT1 is not stored in the retry buffer 48B. In FIG. 14, for convenience, it is assumed that each of the retry buffer 48B and the counter buffer 61 includes the four entries ENT1 to ENT4.

In addition, the additional information recording circuit 68B includes the three entries ENTa1 to ENTa3 in which the retry information RTRY is stored as the retry information RR and the three entries ENTb in which the count value RCN is stored as the count value RRCN. Initial states of the entries ENT of the retry buffer 48B and the entries ENTa of the additional information recording circuit 68B are indicated by “00”. The packets PCKT1 stored in the entries ENT of the retry buffer 48B in order are indicated by “A”, “B”, “C”, “D”, “E”, “F”, “G”, and “H”.

Initial states of the entries ENT of the counter buffer 61 and the entries ENTb of the additional information recording circuit 68B are indicated by “0”. The retry buffer 48B stores the packet of “A” in the entry ENT1 indicated by the pointer value PT based on generation of the packet of “A” by the packet generation circuit 44 and updates the pointer value PT ((a) in FIG. 14). The counter buffer control circuit 62B stores the count value CNT of the counter 63 in the entry ENT1 indicated by the pointer value PT−1 in the counter buffer 61 (FIG. 13) as the count value RCN ((b) in FIG. 14).

In addition, the counter buffer control circuit 62B stores information stored in the entry ENT2 indicated by the pointer value PT in the retry buffer 48B in the entry ENTa1 of the additional information recording circuit 68B as the retry information RR ((c) in FIG. 14). Further, the counter buffer control circuit 62B stores information stored in the entry ENT2 indicated by the pointer value PT in the counter buffer 61 in the entry ENTb1 of the additional information recording circuit 68B as the count value RRCN ((d) in FIG. 14). The retry information RR stored in each of the entries ENTa is transmitted to the entry ENTa of the next stage in order for each of the clock cycles and the count value RRCN stored in each of the entries ENTb is transmitted to the entry ENTb of the next stage in order for each of the clock cycles.

After then, the retry buffer 48B stores the packets of “B”, “C”, and “D” generated by the packet generation circuit 44 in the entry ENT indicated by the pointer value PT in order ((e), (f), and (g) in FIG. 14). The counter buffer control circuit 62B stores the count value CNT in the entry ENT indicated by the pointer value PT−1 in the counter buffer 61 as the count value RCN whenever the point value PT is updated ((h) in FIG. 14). Here, the count value CNT indicates the number of the packets PCKT0 generated between the two packets PCKT1 (for example, A and B).

In addition, the counter buffer control circuit 62B stores the packet PCKT1 stored in the entry ENT indicated by the pointer value PT in the retry buffer 48B in the entry ENTa1 as the retry information RR.

Further, the counter buffer control circuit 62B stores the count value RCN stored in the entry ENT1 corresponding to the pointer value PT in the counter buffer 61 in the entry ENTb as the count value RRCN.

For example, the packet of “A” is stored in the entry ENTa1 as the retry information RR during the clock cycle during which the packet of “D” is stored in the entry ENT3 of the retry buffer 48B ((i) in FIG. 14).

In addition, the count value of “0” (initial value) is stored in the entry ENTb1 as the count value RRCN ((j) in FIG. 14).

Next, the retry buffer 48B stores the packet of “E” generated by the packet generation circuit 44 in the entry ENT1 indicated by the pointer value PT and updates the pointer value PT ((k) in FIG. 14).

Here, the packet of “A” stored in the entry ENT1 is already transmitted to the entry ENTa1 of the additional information recording circuit 68B before being overwritten by the packet of “E”.

Next, the retry buffer 48B stores the packet of “F” generated by the packet generation circuit 44 in the entry ENT2 indicated by the pointer value PT and updates the pointer value PT ((I) in FIG. 14).

The counter buffer control circuit 62B stores the count value CNT of “4” in the entry ENT2 indicated by the pointer value PT−1 in the counter buffer 61 ((m) in FIG. 14). Here, the packet of “B” stored in the entry ENT2 of the retry buffer 48B is already transmitted to the entry ENTa1 of the additional information recording circuit 68B before being overwritten by the packet of “F” ((n) in FIG. 14). The count value CNT of “5” stored in the entry ENT2 of the counter buffer 61 is already transmitted to the entry ENTb1 of the additional information recording circuit 68B before being overwritten by the count value CNT of “4” ((o) in FIG. 14).

As illustrated in FIG. 14, by providing the additional information recording circuit 68B to the memory controller 30, it is possible to transmit the packet PCKT1 and the count value CNT stored in the retry buffer 48B and the counter buffer 61 to the additional information recording circuit 68B.

Accordingly, it is possible to store the larger number of the packets PCKT1 and the larger number of the packets PCKT0 generated between the two packets PCKT1 than the number of the entries ENT of the retry buffer 48B in the memory controller 30.

For example, in some cases, the memory controller 30 is newly designed by using the already designed retry buffer 48B. In this case, it is possible to store the desired number of the packets PCKT1 and information on the number of the packets PCKT0 in the memory controller 30 regardless of the number of the entries ENT of the retry buffer 48B. As a result, it is possible to increase the number of the packets PCKT1 and PCKT0 traceable by the debugger 102B according to the number of the entries ENTa and ENTb of the additional information recording circuit 68B.

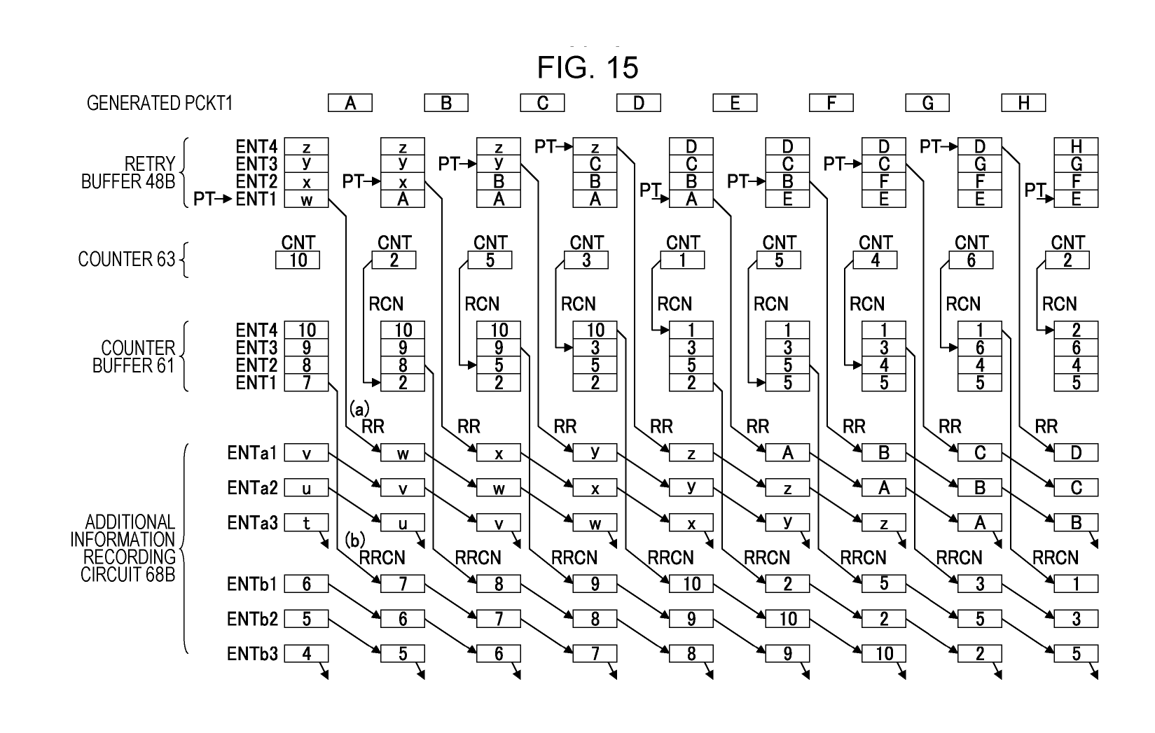

FIG. 15 illustrates another example of an operation of the memory controller 30 illustrated in FIG. 12. A detailed explanation for the same operation as FIG. 14 will be omitted. FIG. 15 illustrates an example in which the packets of “A”, “B”, “C”, “D”, “E”, “F”, “G”, and “H” illustrated in FIG. 14 are stored in the retry buffer 48B in order in a state in which the packets of “w”, “x”, “y”, and “z” are stored in all of the entries ENT1 to ENT4 of the retry buffers 48B. The count values CNT of (“7”, “8”, “9”, and “10”) corresponding to the packets of “w”, “x”, “y”, and “z” are respectively stored in the entries ENT1 to ENT4 of the counter buffer 61.

As illustrated in FIG. 15, before the packet of “A” is stored in the entry ENT1 of the retry buffer 48B, the packet of “w” stored in the entry ENT1 is transmitted to the additional information recording circuit 68B ((a) in FIG. 15). Before the count value CNT of “2” corresponding to the packet of “A” is stored in the entry ENT1 of the counter buffer 61, the count value CNT of “7” stored in the entry ENT1 is transmitted to the additional information recording circuit 68B ((b) in FIG. 15). In FIG. 15, for example, the interrupt signal INT (FIG. 12) occurs during the clock cycle during which the packet of “E” is stored in the retry buffer 48B.

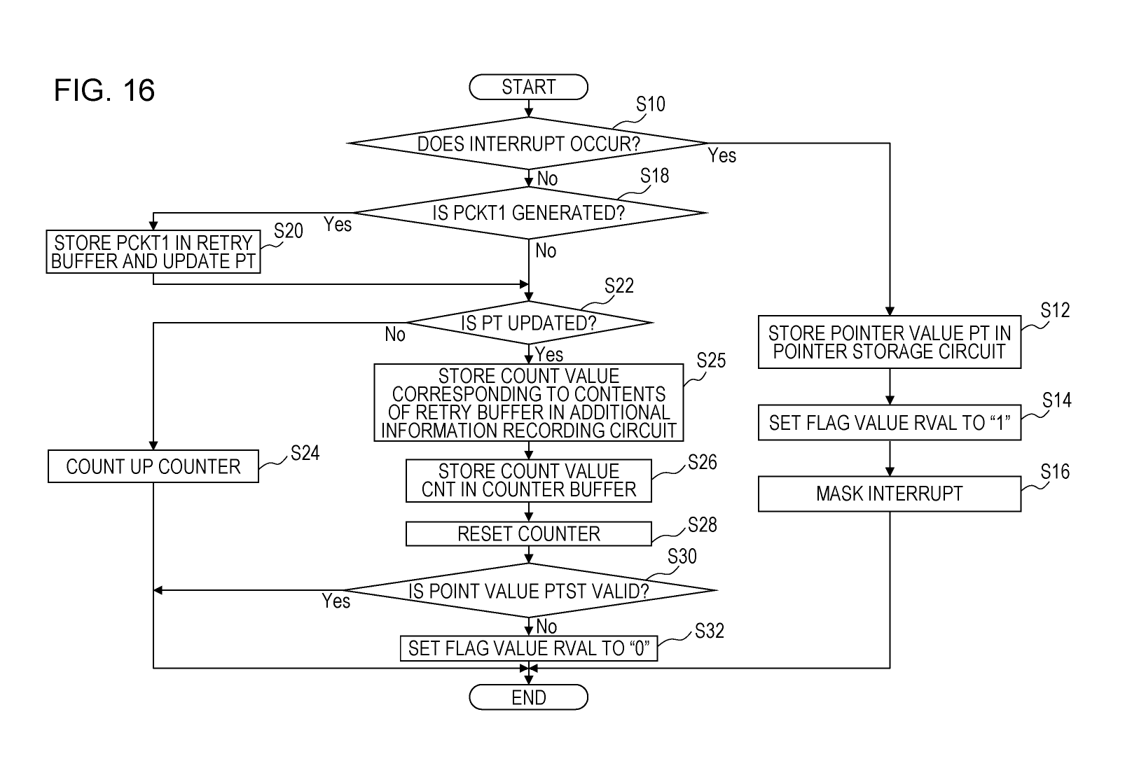

In this case, the debugger 102B can trace the packets PCKT1 (y, z, A, B, C, D, and E) and the packets PCKT0 generated between the packet of “y” and the packet of “E”. On the other hand, in a case where the additional information recording circuit 68B is not included in the memory controller 30, the packets traceable by the debugger 102B are the packets PCKT1 (B, C, D, and E) and the packets PCKT0 generated between the packet of “B” and the packet of “E”. FIG. 16 illustrates an example of an operation flow of the transmission information recording circuit 50B illustrated in FIG. 13.

That is, FIG. 16 illustrates an example of the transmission information storage method and an example of the control method of the memory controller 30. A detailed explanation for the same operation as FIG. 11 will be omitted. FIG. 16 illustrates the same operation as FIG. 11 except that step S25 is inserted between step S22 and step S26. In a case where it is determined that the pointer value PT is updated based on generation of the new packet PCKT1 in step S22, the operation is moved to step S25. In step S25, the counter buffer control circuit 62B stores the packet PCKT1 stored in the entry ENT indicated by the pointer value PT in the retry buffer 48B in the entry ENTa1 of the additional information recording circuit 68B as the retry information RR.

In addition, the counter buffer control circuit 62B stores the count value RCN stored in the entry ENT indicated by the pointer value PT in the counter buffer 61 in the entry ENTb1 of the additional information recording circuit 68B as the count value RRCN.

Then, the operation is moved to step S26. Even in the embodiments illustrated in FIGS. 12 to 16, the same effects as embodiments illustrated in FIGS. 1 to 11 also can be obtained. That is, it is possible to decrease scale of a circuit used for tracing the packets PCKT1 and PCKT0 transmitted to the memory 20 as compared with a case where a buffer in which information itself included in the packet PCKT0 is stored is provided in the memory controller 30. Further, in the embodiments illustrated in FIGS. 12 to 16, the additional information recording circuit 68B is provided in the memory controller 30.

Accordingly, by the pointer value PT making one around, even in a case where the packet PCKT1 stored in the retry buffer 48B is overwritten, it is possible to store the overwritten packet PCKT1 and the count value RCN in the additional information recording circuit 68B. Further, it is possible to store the desired number of the packets PCKT1 and information on the number of the packets PCKT0 in the memory controller 30 regardless of the number of the entries ENT of the retry buffer 48B. That is, it is possible to increase the number of the packets PCKT1 and PCKT0 traceable by the debugger 102B according to the number of the entries ENTa and ENTb of the additional information recording circuit 68B.

As specifically described above, features and advantages of the embodiments are clarified. This is intended to cover the features and advantages of the embodiments as described above without departing from the spirit and scope of the claims.

In addition, anyone having ordinary skill in the art can easily improve and modify all of the embodiments.

Therefore, there is no intention to limit the scope of the embodiment having the inventive aspect to those described above and it is also possible to rely on appropriate improvements and equivalents included in the range disclosed in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a memory; and
a processor configured to include a memory controller that controls transmission and reception of information to and from the memory,
wherein the memory controller comprises
a first buffer that includes a plurality of first storage regions,
a first control circuit that stores, in one of the plurality of first storage regions, first information that operates the memory among pieces of information transmitted to the memory,
a counter that counts a number of pieces of second information transmitted to the memory, the second information being information transmitted to the memory since the first information is transmitted to the memory until the next first information is transmitted to the memory and indicating no-transmission of the first information,
a second buffer that includes a plurality of second storage regions respectively corresponding to the plurality of first storage regions, and
a second control circuit that stores a count value of the counter in one of the plurality of second storage regions in association with the first information stored in the first storage region.

2. The information processing device according to claim 1,
wherein the first control circuit manages the first storage region in which the first information is stored among the plurality of first storage regions by using a pointer and updates a value of the pointer whenever the first information is stored in the first storage region, and
the counter is reset based on the updating of the value of the pointer, and then counts the number of the pieces of the second information transmitted to the memory.

3. The information processing device according to claim 2,
wherein the memory controller further comprises
a pointer memory that stores the value of the pointer, and
a pointer control circuit that stores the value of the pointer in the pointer memory based on an error response to the first information transmitted to the memory from the memory.

4. The information processing device according to claim 3,
wherein the first control circuit stores cyclically the first information in the plurality of first storage regions,
the memory controller further comprises
a flag that indicates whether the value of the pointer stored in the pointer memory is valid, and
the pointer control circuit sets the flag to a valid state based on writing of the value of the pointer to the pointer memory and in a case where the value of the pointer makes one round and matches the value of the pointer stored in the pointer memory, the pointer control circuit sets the flag to an invalid state.

5. The information processing device according to claim 2,
wherein the memory controller further comprises
a plurality of third storage regions,
a plurality of fourth storage regions that respectively corresponds to the plurality of third storage regions, and
a third control circuit that stores the first information stored before the new first information is stored in the first storage region indicated by the pointer among the plurality of first storage regions in one of the plurality of third storage regions and store the count value stored in the second storage region corresponding to the first storage region indicated by the pointer among the plurality of second storage regions in the fourth storage region corresponding to the third storage region in which the first information is stored among the plurality of fourth storage regions.

6. The information processing device according to claim 1, further comprising:
a trace circuit that traces information transmitted to the memory by using the plurality of pieces of the first information stored in the plurality of first storage regions and the plurality of count values stored in the plurality of second storage regions.

7. The information processing device according to claim 1, further comprising:
an information generation circuit that generates the first information based on a memory access request and generate the second information during a period when the first information is not generated.

8. A processor comprising:
a memory controller configured to control transmission and reception of information to and from a memory,
wherein the memory controller includes
a plurality of first storage regions,
a first control circuit configured to store first information operating the memory among pieces of information transmitted to the memory in one of the plurality of first storage regions,
a counter configured to count a number of pieces of second information transmitted to the memory, the second information being information transmitted to the memory since the first information is transmitted to the memory until the next first information is transmitted to the memory and indicating no-transmission of the first information,
a plurality of second storage regions configured to respectively correspond to the plurality of first storage regions, and
a second control circuit configured to store a count value of the counter in one of the plurality of second storage regions in association with the first information stored in the first storage region.

9. A transmission information storage method for storing information to be transmitted to a memory by a memory controller that controls transmission and reception of information to and from a memory, the method comprising:
causing the memory controller to store first information for operating the memory among pieces of information transmitted to the memory in one of the plurality of first storage regions,
causing the memory controller to count a number of pieces of second information transmitted to the memory, the second information being information transmitted to the memory since the first information is transmitted to the memory until the next first information is transmitted to the memory and for indicating no-transmission of the first information, and
causing the memory controller to store a count value obtained by the counter in one of the plurality of second storage regions in association with the first information stored in the first storage region.
